(19) United States
(12) Patent Application Publication
(10) Pub. No.: US 2024/0002282 A1
(43) Pub. Date: Jan. 4, 2024

(54) CHEMICALLY STRENGTHENED GLASS AND MANUFACTURING METHOD THEREFOR

(71) Applicant: AGC Inc., Tokyo (JP)

(72) Inventors: Takumi UMADA, Chiyoda-ku (JP); Qing LI, Chiyoda-ku (JP); Yusuke FUJIWARA, Chiyoda-ku (JP); Yusuke KATAOKA, Chiyoda-ku (JP)

(73) Assignee: AGC Inc., Tokyo (JP)

(21) Appl. No.: 18/468,969

(22) Filed: Sep. 18, 2023

Related U.S. Application Data
(63) Continuation of application No. PCT/JP2022/017214, filed on Apr. 6, 2022.

(30) Foreign Application Priority Data
Apr. 7, 2021 (JP) 2021-065434
Dec. 20, 2021 (JP) 2021-206353

(51) Int. Cl. C03C 10/00; C03C 21/00

(52) U.S. Cl. CPC C03C 10/0027; C03C 21/002

(57) ABSTRACT

The present invention relates to a chemically strengthened glass having a thickness of t [μm] and including Li₂O, K₂O, and Na₂O, in which a minimum depth z at which Kₓ is (K_{t/2}+0.1) [%] or more is 0.5 μm to 5 μm, provided that Kₓ [%] is a concentration of K₂O at a depth of x [μm] from a surface of the chemically strengthened glass and K_{t/2} [%] is a content of K₂O before chemical strengthening, in terms of mole percentage based on oxides.

### CROSS-REFERENCE TO RELATED APPLICATIONS

This is a continuation of International Application No. PCT/JP2022/017214 filed on Apr. 6, 2022, and claims priority from Japanese Patent Application No. 2021-065434 filed on Apr. 7, 2021 and Japanese Patent Application No. 2021-206353 filed on Dec. 20, 2021, the entire content of which is incorporated herein by reference.

### TECHNICAL FIELD

The present invention relates to a chemically strengthened glass and a manufacturing method therefor.

### BACKGROUND ART

A chemically strengthened glass is used for a cover glass or the like of a mobile terminal. The chemically strengthened glass is obtained by, for example, bringing a glass into contact with a molten salt containing alkali metal ions to cause ion exchange between the alkali metal ions in the glass and alkali metal ions in the molten salt, thereby forming a compressive stress layer on the glass surface.

As a base material of such a chemically strengthened glass, an amorphous glass containing Li₂O and glass ceramics containing Li₂O are particularly excellent. This is because a compressive stress is easily formed even in a deep portion in the chemically strengthened glass by ion exchange between lithium ions contained in the base material and sodium ions contained in a strengthening salt. Since the lithium ions and the sodium ions have relatively small ionic radii, diffusion coefficients due to ion exchange are large. Further, this is because the amorphous glass and glass ceramics containing Li₂O have relatively large fracture toughness values and tend to be resistant to break.

The cover glass of the mobile terminal is also required to have good finger slipperiness during operation. For this reason, a surface of the cover glass is often coated. However, the formed coating film may be easily peeled off.

Patent Literature 1 discloses glass ceramics having excellent chemical strengthening properties. Patent Literature 2 discloses a chemically strengthened glass that is excellent in strength and is resistant to peeling of a coating for improving finger slipperiness.

### CITATION LIST

### Patent Literature

Patent Literature 1: WO 2019/022032
Patent Literature 2: WO 2021/010376

### SUMMARY OF INVENTION

### Technical Problem

One of reasons why the glass containing Li₂O is excellent as the cover glass is that a compressive stress value generated by chemical strengthening can be easily controlled to a preferable value because Li ions in the glass can be ion-exchanged with both Na ions and K ions contained in the molten salt.

However, Patent Literature 2 describes that the coating tends to be easily peeled off as surface resistivity or the like of the chemically strengthened glass increases. It is also described that a content ratio of an alkali metal oxide affects the surface resistivity.

For example, a glass containing three kinds of alkali metal oxides of Li₂O, Na₂O, and K₂O has larger surface resistivity due to a mixed alkali effect, compared to a glass containing only one or two kinds of alkali metal oxides even though the glass contains the same amount of alkali metal oxides.

That is, when the glass containing Li₂O is chemically strengthened, as a result, a chemically strengthened glass containing three kinds of Li₂O, Na₂O, and K₂O is obtained, and peeling of the coating tends to occur. Further, when a glass composition before strengthening and chemical strengthening treatment conditions are adjusted in order to prevent peeling of a coating after chemical strengthening, there is a problem that it is difficult to obtain sufficient strength by the chemical strengthening.

Therefore, an object of the present invention is to provide a chemically strengthened glass that exhibits excellent chemical strengthening properties and can prevent peeling of a coating.

### Solution to Problem

The present inventors have found that in a chemically strengthened glass containing Li₂O, K₂O, and Na₂O, an increase in surface resistivity due to a mixed alkali effect can be prevented by making a region containing potassium in an extremely shallow portion from a glass surface, and have completed the present invention.

The present invention relates to a chemically strengthened glass having a thickness of t [μm] and including Li₂O, K₂O, and Na₂O, in which a minimum depth z at which Kₓ is (K_{t/2}+0.1) [%] or more is 0.5 μm to 5 μm, provided that Kₓ [%] is a concentration of K₂O at a depth of x [μm] from a surface of the chemically strengthened glass and K_{t/2} [%] is a content of K₂O before chemical strengthening, in terms of mole percentage based on oxides.

In the present chemically strengthened glass, |Na_{z}-Na₅₀|<3 [%] is preferably satisfied, provided that Na_{z} [%] is a concentration of Na₂O at the minimum depth z [μm] at which Kₓ is (K_{t/2}+0.1) [%] or more where Kₓ [%] is the concentration of K₂O at the depth of x [μm] from the surface of the chemically strengthened glass and K_{t/2} [%] is the content of K₂O before chemical strengthening, and Na₅₀ [%] is a concentration of Na₂O at a depth of 50 μm from the surface of the chemically strengthened glass, in terms of mole percentage based on oxides.

In the present chemically strengthened glass. Na₅₀<Na_{t/2}+7 [%] is preferably satisfied, provided that Na₅₀ [%] is a concentration of Na₂O at a depth of 50 μm from the surface of the chemically strengthened glass and Na_{t/2} [%] is a content of Na₂O before chemical strengthening, in terms of mole percentage based on oxides.

In the present chemically strengthened glass, (Li_{t/2}+Na_{t/2}+K_{t/2})−2(Na₁+K₁)>0 [%] is preferably satisfied, provided that K₁ [%] is a concentration of K₂O at a depth of 1 μm from the surface of the chemically strengthened glass, Na₁ [%] is a concentration of Na₂O at a depth of 1 μm from the surface of the chemically strengthened glass, and Litz [%], Na_{t/2} [%], and K_{t/2} [%] are contents of Li₂O, Na₂O, and K₂O before chemical strengthening, respectively, in terms of mole percentage based on oxides.

In the present chemically strengthened glass, it is preferable that a surface compressive stress value CS₀ is 450 MPa or more, a compressive stress value CS₅₀ at a depth of 50 μm from the surface of the chemically strengthened glass is 150 MPa or more, and a compressive stress value CS₉₀ at a depth of 90 μm from the surface of the chemically strengthened glass is 30 MPa or more.

In the present chemically strengthened glass, it is preferable that a surface compressive stress value CS₀ is 450 MPa or more, a compressive stress value CS₅₀ at a depth of 50 μm from the surface of the chemically strengthened glass is y=124.7×t+21.5 [MPa] or more, and a compressive stress value CS₉₀ at a depth of 90 μm from the surface of the chemically strengthened glass is y=99.1×t−38.3 [MPa] or more.

The present invention also relates to a chemically strengthened glass, in which
a K ion penetration depth D is 0.5 μm to 5 μm,
an absolute value of a difference between a compressive stress value at the K ion penetration depth D and a compressive stress value CS₅₀ at a depth of 50 μm from a surface of the chemically strengthened glass is 150 MPa or less,
the compressive stress value at the K ion penetration depth D is 350 MPa or less, and
a surface compressive stress value CS₀ is 450 MPa or more, the compressive stress value CS₅₀ at the depth of 50 μm from the surface of the chemically strengthened glass is 150 MPa or more, and a compressive stress value CS₉₀ at a depth of 90 μm from the surface of the chemically strengthened glass is 30 MPa or more.

The present chemically strengthened glass preferably includes a glass ceramic.

A base composition of the present chemically strengthened glass preferably includes 40% to 75% of SiO₂, 1% to 20% of Al₂O₃, and 5% to 35% of Li₂O in terms of mole percentage based on oxides.

The present chemically strengthened glass is preferably a chemically strengthened glass subjected to two or more stages of ion exchange, and CTave after first ion exchange, which is initial ion exchange, is preferably larger than CTA, provided that the CTA is calculated by the following Formula (1), and the CTave is calculated by the following Formula (2).

[Math. 1]

CTA=317.93×K1c/\sqrt{t}+228.5×t−398 Formula (1)
t: sheet thickness (μm)
K1c: fracture toughness value (MPa·m^{1/2})

CTave=ICT/L_{CT} Formula (2)
ICT: integral value of tensile stress (Pa·m)
L_{CT}: length (μm) of tensile stress region in sheet thickness direction

The present chemically strengthened glass preferably has a thickness t of 300 μm to 1500 μm.

In the present chemically strengthened glass, −1000 MPa/μm<P₀<−225 MPa/μm is preferably satisfied, provided that P₀ is an inclination of a glass surface layer defined by a formula CS₀/D, and in the formula. CS₀ is the surface compressive stress value (MPa), and D is the K ion penetration depth (μm).

In the present chemically strengthened glass, |P₅₀₋₉₀|>|P_{90-DOL}|, and 1.8<|P₅₀₋₉₀|<6.0 and 1.5<|P_{90-DOL}|<4.0 are preferably satisfied, provided that P₅₀₋₉₀ (MPa/μm) is an inclination of a stress profile of the chemically strengthened glass in a region between the depth of 50 μm from the surface of the chemically strengthened glass and the depth of 90 μm from the surface of the chemically strengthened glass, and P_{90-DOL} (MPa/μm) is an inclination of a stress profile of the chemically strengthened glass in a region between the depth of 90 μm from the surface of the chemically strengthened glass and a depth (DOL) (μm) at which a compressive stress value is zero,
provided that the P₅₀₋₉₀ and the P_{90-DOL} are calculated by the following formulas,

P₅₀₋₉₀=(CS₅₀−CS₉₀)/40; and

P_{90-DOL}=CS₉₀/(DOL−90).

In the present chemically strengthened glass, |P₅₀₋₉₀|<|P_{90-DOL}|, and 1.0<|P₅₀₋₉₀|<3.0 and 1.2<P_{90-DOL}|<4.0 are preferably satisfied, provided that P₅₀₋₉₀ (MPa/μm) is an inclination of a stress profile of the chemically strengthened glass in a region between the depth of 50 μm from the surface of the chemically strengthened glass and the depth of 90 μm from the surface of the chemically strengthened glass, and P_{90-DOL} (MPa/μm) is an inclination of a stress profile of the chemically strengthened glass in a region between the depth of 90 μm from the surface of the chemically strengthened glass and a depth (DOL) (μm) at which a compressive stress value is zero,
provided that the P₅₀₋₉₀ and the P_{90-DOL} are calculated by the following formulas,

P₅₀₋₉₀=(CS₅₀−CS₉₀)/40; and

P_{90-DOL}=CS₉₀/(DOL−90).

The present invention also relates to a method for producing a chemically strengthened glass including Li₂O, K₂O, and Na₂O, the method including chemically strengthening a glass having a thickness of t [μm] and including Li₂O, in which chemical strengthening is performed so that a minimum depth z at which Kₓ is (K_{t/2}+0.1) [%] or more is 0.5 μm to 5 μm, provided that Kₓ [%] is a concentration of K₂O at a depth of x [μm] from a surface of the chemically strengthened glass and K_{t/2} [%] is a content of K₂O of the glass before the chemical strengthening, in terms of mole percentage based on oxides of the chemically strengthened glass.

In the present method for producing a chemically strengthened glass, the glass including Li₂O preferably includes a glass ceramic.

In the present method for producing a chemically strengthened glass, the chemical strengthening preferably includes two or more stages of ion exchange, and CTave after first ion exchange, which is initial ion exchange, is preferably larger than CTA, provided that the CTA is calculated by the following Formula (1), and the CTave is calculated by the following Formula (2).

[Math. 2]

CTA=317.93×K1c/\sqrt{t}+228.5×t−398 Formula (1)
t: sheet thickness (μm)
K1c: fracture toughness value (MPa·m^{1/2})

CTave=ICT/L_{CT} Formula (2)
ICT: integral value of tensile stress (Pa·m)
L_{CT}: length (μm) of tensile stress region in sheet thickness direction

### Advantageous Effects of Invention

The chemically strengthened glass of the present invention exhibits excellent chemical strengthening properties, and has an advantage that an increase in surface resistivity due to a mixed alkali effect is prevented and a coating is less likely to be peeled off because a region containing potassium is in an extremely shallow portion from a glass surface.

### BRIEF DESCRIPTION OF DRAWINGS

FIG. 1A and FIG. 1B show a result of measuring a concentration of Na in a chemically strengthened glass by EPMA. FIG. 1C and FIG. 1D show a result of measuring a concentration of K in the chemically strengthened glass by EPMA. In FIG. 1A to FIG. 1D, a horizontal axis indicates a depth (μm) from a glass surface, and a vertical axis indicates a concentration (%) expressed in terms of mole percentage based on oxides.

FIG. 2 shows a stress profile of a chemically strengthened glass of one embodiment of the present invention.

### DESCRIPTION OF EMBODIMENTS

In the specification, “to” indicating a numerical range is used in the sense of including the numerical values set forth before and after the “to” as a lower limit value and an upper limit value, unless otherwise specified.

In the specification, an “amorphous glass” refers to a glass in which a diffraction peak indicating a crystal is not observed by powder X-ray diffraction to be described later. The “glass ceramic” is obtained by subjecting the “amorphous glass” to heat treatment to precipitate crystals, and contains crystals. In the specification, the “amorphous glass” and the “glass ceramic” may be collectively referred to as the “glass”. The amorphous glass that becomes glass ceramic by a heat treatment may be referred to as a “base glass of glass ceramic”.

In the present specification, in powder X-ray diffraction measurement, for example, 2θ is measured in a range of 10° to 80° using a CuKα ray, and when a diffraction peak appears, precipitated crystals are identified by Hanawalt method. A crystal identified from a peak group including a peak having the highest integrated intensity among the crystals identified by the method is defined as a main crystal. For example, SmartLab manufactured by Rigaku Corporation can be used as a measurement device.

In the present specification, a concentration of K, Na, or Li at a depth of x [μm] is measured by an electron probe micro analyzer (EPMA) in a cross section in a sheet thickness direction. The measurement by EPMA is specifically performed as follows, for example.

First, a glass sample is embedded with an epoxy resin and mechanically polished in a direction perpendicular to a first main surface and a second main surface opposite to the first main surface to prepare a cross-sectional sample. A C coat is applied to the polished cross section, and measurement is performed using an EPMA (JXA-8500F manufactured by JEOL Ltd.). A line profile of an X-ray intensity of K, Na, or Li is obtained at intervals of 1 μm with an acceleration voltage of 15 kV, a probe current of 30 nA, and an integration time of 1000 msec./point.

In the following, a “chemically strengthened glass” refers to a glass after a chemical strengthening treatment, and a “glass for chemical strengthening” refers to a glass before the chemical strengthening treatment.

In the specification, a glass composition is expressed in terms of mol % based on oxides unless otherwise specified, and mol % is simply expressed as “%”.

In the specification, “substantially not contained” means that a component has a content less than an impurity level contained in the raw materials and the like, that is, the component is not intentionally added. Specifically, the content is, for example, less than 0.1%.

In the present specification, the term “stress profile” represents a compressive stress value with a depth from a glass surface as a variable. In the stress profile, a tensile stress is expressed as a negative compressive stress.

A “compressive stress value (CS)” can be measured by slicing a cross section of a glass and analyzing the sliced sample with a birefringent imaging system. A birefringence index stress meter of the birefringent imaging system is a device for measuring a magnitude of retardation caused by stress using a polarization microscope, a liquid crystal compensator. or the like, and for example, there is a birefringent imaging system Abrio-IM manufactured by CRi.

In addition, measurement may be performed using scattered light photoelasticity. In the method, light is incident from a surface of the glass, and polarization of scattered light thereof is analyzed to measure CS. For example, a scattered light photoelastic stress meter SLP-2000 manufactured by Orihara Industrial Co., Ltd is used as a stress measurement instrument using the scattered light photoelasticity.

In the specification, a “K ion penetration depth D” is obtained by the following procedures (1) to (3).
(1) First, a profile of compressive stress values (CS) of a chemically strengthened glass in a depth direction is measured using the scattered light photoelastic stress meter SLP-2000 manufactured by Orihara Industrial Co., Ltd.
(2) Next, for the same chemically strengthened glass as the chemically strengthened glass whose profile of compressive stress values in a depth direction is measured using SLP-2000 in (1), the profile in a depth direction is measured by the following method.

While one surface of the glass is sealed, the glass is immersed in an acid of 1% HF-99% H₂O in terms of volume fraction, and only one surface is etched to arbitrary thickness. This causes a stress difference between front and back surfaces of the chemically strengthened glass, and the glass warps according to the stress difference. The amount of warpage is measured using a contact shape meter (Surftest manufactured by Mitutoyo Corporation). The amount of warpage is measured at three or more etching depths.

The obtained amount of warpage is converted into stress using the formula shown in the following document to obtain a profile of compressive stress values in the depth direction. Document: G. G. Stoney, Proc. Roy. Soc. London Ser. A, 82, 172 (1909).
(3) The two profiles obtained by the procedures (1) and (2) are overlapped, and a depth of an intersection point is the “K ion penetration depth D”.

In the etching treatment, the warpage caused by polishing using a rotary polishing machine (apparatus name: 9B-5P, manufacturer: SPEEDFAM) may be measured with a contact shape meter (apparatus name: SV-600, manufacturer: Mitutoyo Corporation). In particular, in the case of using glass ceramics for the present chemically strengthened glass, since the etching treatment with the acid cannot be performed correctly, it is preferable to measure the amount of warpage using the rotary polishing machine (apparatus name: 9B-5P, manufacturer: SPEEDFAM) and the contact shape meter (apparatus name: SV-600, manufacturer: Mitutoyo Corporation).

In the specification, the “depth of compressive stress layer (DOL)” is a depth at which the compressive stress value is zero. Hereinafter, a surface compressive stress value may be referred to as CS₀, and a compressive stress value at a depth of 50 μm from the surface may be referred to as CS₅₀. An “internal tensile stress (CT)” refers to a tensile stress value at a depth of ½ of a sheet thickness t, and is equivalent to “CS_{t/2}” in the specification.

In the specification. “light transmittance” refers to average transmittance in light having a wavelength of 380 nm to 780 nm. A “haze value” is measured in accordance with JIS K7136: 2000 using a halogen lamp C light source.

In the specification, a “fracture toughness value” is a value according to the IF method defined in JIS R1607: 2015.

In the specification, “surface resistivity” is measured using a non-contact conductivity meter.

In the specification, “#180 drop strength” and “#80 drop strength” are measured by the following method.

A glass sample of 120×60×0.6 mmt was fitted into a structure whose mass and rigidity were adjusted according to a size of a general smartphone, and thus a pseudo smartphone was prepared. Then, the pseudo smartphone was freely dropped onto #180 SiC sandpaper for #180 drop strength or onto #80 SiC sandpaper for #80 drop strength. A drop height is measured by repeating an operation of dropping the glass sample from a height of 5 cm, and if the glass sample is not broken, raising the height by 5 cm and dropping the glass sample again until the glass sample is broken, and measuring an average value of heights of 10 sheets of glass samples when the glass samples are broken for the first time.

In the specification, AFP durability (10000 times) is measured by an eraser abrasion test under the following conditions.

Eraser Abrasion Test Conditions:

A surface of the chemically strengthened glass sheet is cleaned with ultraviolet rays, and is spray-coated with Optool (registered trademark) DSX (manufactured by Daikin Industries, Ltd.) to form a substantially uniform AFP film on the surface of the glass sheet.

An eraser (minoan, manufactured by MIRAE SCIENCE) is attached to an indenter of 1 cm², and a surface of the AFP film formed on the surface of the glass sheet was subjected to reciprocating friction 10000 times at a stroke width of 20 mm and a speed of 30 mm/sec under a load of 1 kgf. Then, the surface of the AFP film is cleaned by dry wiping with a cloth [DUSPER (registered trademark) manufactured by Ozu Corporation], and then water contact angles (°) are measured at three positions on the surface of the AFP film. The operation is repeated three times to measure an average water contact angle (°) of water contact angles at a total of nine positions. The water contact angle (°) on the surface of the AFP film is measured by a method in accordance with JIS R3257 (1999).

In the specification, “4PB strength” (four-point bending strength) is measured by the following method.

The “4PB strength” can be evaluated by performing a four-point bending test using a strip-shaped test piece of 120 mm×60 mm under the conditions that a distance between external fulcrums of a support is 30 mm, a distance between internal fulcrums of the support is 10 mm, and a crosshead speed is 5.0 mm/min. The number of test pieces is, for example, 10.

<Chemically Strengthened Glass>

The chemically strengthened glass of the present invention (hereinafter also referred to as a “present chemically strengthened glass”) is typically a sheet-shaped glass article, and may be in the form of a flat sheet or a curved surface. Further, there may be portions having different thicknesses.

In a case where the present chemically strengthened glass is sheet-shaped, the thickness (t) thereof is preferably 3000 μm or less, more preferably 2000 μm or less, 1600 μm or less, 1500 μm or less, 1100 μm or less, 900 μm or less, 800 μm or less, or 700 μm or less in a stepwise manner. In order to obtain sufficient strength by the chemical strengthening treatment, the thickness (t) is preferably 300 μm or more, more preferably 400 μm or more, and still more preferably 500 μm or more.

### Embodiment 1

Embodiment 1 of the present chemically strengthened glass is a chemically strengthened glass having a thickness of t [μm], in which a minimum depth z at which Kₓ is (K_{t/2}+0.1) [%] or more is 0.5 μm to 5 μm, where Kₓ [%] is a concentration of K₂O at a depth of x [μm] from a surface and K_{t/2} [%] is a content of K₂O before chemical strengthening, in terms of mole percentage based on oxides. Z is preferably 0.6 μm to 4.5 μm, more preferably 0.7 μm to 4 μm, still more preferably 0.8 μm to 3.5 μm, and particularly preferably 0.85 to 3. Since the depth z is 0.5 μm to 5 μm, an increase in surface resistivity due to an alkali mixing effect can be prevented.

A glass composition before chemical strengthening is equivalent to a composition at a center of a sheet thickness (glass center portion). Specifically, the contents of Li₂O, Na₂O, and K₂O before chemical strengthening are equivalent to the contents of Li₂O, Na₂O, and K₂O at a position of t/2, where t is the sheet thickness of the present chemically strengthened glass.

In Embodiment 1 of the present chemically strengthened glass, |Na_{z}-Na₅₀| is preferably less than 3%, where Na_{z} [%] is a concentration of Na₂O at the minimum depth z [μm] at which Kₓ is (K_{t/2}+0.1) [%] or more where Kₓ [%] is the concentration of K₂O at the depth of x [μm] from the surface and K_{t/2}[%] is the content of K₂O before chemical strengthening, and Na₅₀ [%] is a concentration of Na₂O at a depth of 50 μm from the surface, in terms of mole percentage based on oxides. |Na_{z}-Na₅₀| is more preferably 2.5% or less, and still more preferably 2% or less.

In a general chemically strengthened glass, a concentration of Na increases from a center of the glass to a surface of the glass. However, |Na_{z}-Na₅₀| is less than 3%, and thus a profile of concentrations of the sodium in the glass becomes flat, an alkali mixing degree becomes lower compared to the general chemically strengthened glass, and an increase in surface resistivity can be more effectively prevented. A lower limit of |Na_{z}-Na₅₀| is not particularly limited, but is typically 0.1% or more.

In Embodiment 1 of the present chemically strengthened glass, Na₅₀ is preferably less than (Na_{t/2}+7)%, where Na₅₀ [%] is a concentration of Na₂O at a depth of 50 μm from the surface and Na_{t/2} [%] is a content of Na₂O before chemical strengthening, in terms of mole percentage based on oxides. Na₅₀ is more preferably (Na_{t/2}+5.5)% or less, and still more preferably (Na_{t/2}+4)% or less.

Since Na₅₀ is less than (Na_{t/2}+7)%, an alkali mixing degree on the surface of the glass becomes lower, and an increase in surface resistivity can be more effectively prevented. A lower limit of Na₅₀ is not particularly limited, but is preferably (Na_{t/2}+2)% or more in order to achieve a balance with prevention of glass fracture due to compressive stress.

In Embodiment 1 of the present chemically strengthened glass, [(Li_{t/2}+Na_{t/2}+K_{t/2})−2(Na₁+K₁)] is preferably more than 0%, where K₁ [%] is a concentration of K₂O at a depth of 1 [μm] from the surface, Na₁ [%] is a concentration of Na₂O at a depth of 1 [μm] from the surface, and Li_{t/2} [%], Na_{t/2} [%], and K_{t/2} [%] are contents of Li₂O, Na₂O, and K₂O before chemical strengthening, respectively, in terms of mole percentage based on oxides. [(Li_{t/2}+Na_{t/2}+K_{t/2})−2(Na₁+K₁)] is more preferably 3% or more, and still more preferably 5% or more.

Since [(Li_{t/2}+Na_{t/2}+K_{t/2})−2(Na₁+K₁)] is more than 0%, an alkali mixing degree on the surface of the glass becomes lower, and an increase in surface resistivity can be more effectively prevented. An upper limit of [(Li_{t/2}+Na_{t/2}+K_{t/2})−2(Na₁+K₁)] is not particularly limited, but is typically preferably 15% or less.

In Embodiment 1 of the present chemically strengthened glass, Na_{z}—Na_{t/2} is preferably 8% or less, more preferably 7% or less, and still more preferably 6% or less, where t is a sheet thickness. Since Na_{z}—Na_{t/2} is 8% or less, an alkali mixing degree on the surface of the glass becomes lower, and an increase in surface resistivity can be more effectively prevented. A lower limit of Na_{z}—Na_{t/2} is not particularly limited, but is typically preferably 2% or more.

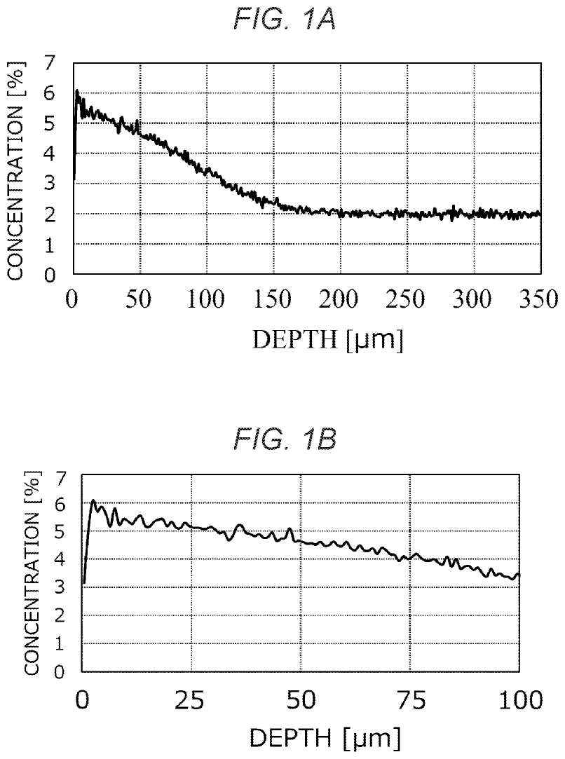

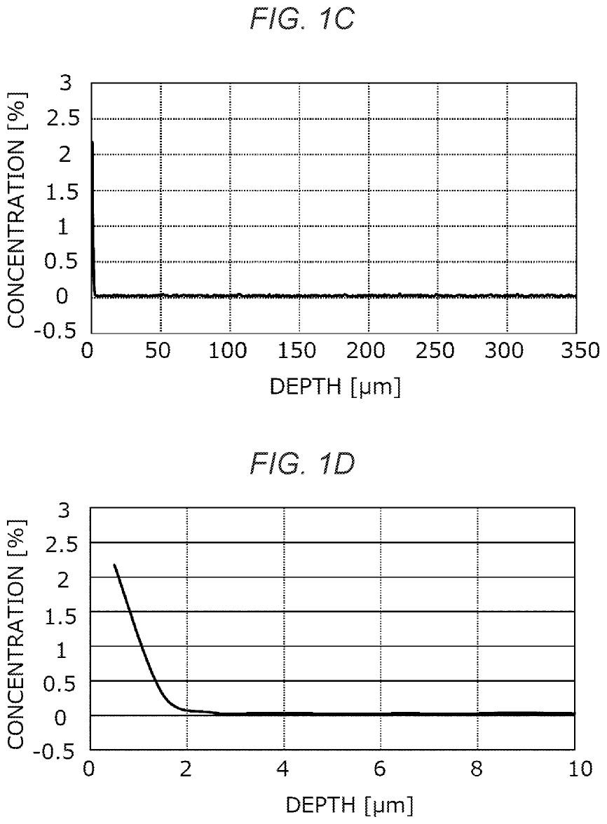

In one embodiment of the present chemically strengthened glass. Na ion profiles are shown in FIG. 1A and FIG. 1B, and K ion profiles are shown in FIG. 1C and FIG. 1D. As shown in FIG. 1A and FIG. 1B, the amount of Li ions in the glass exchanged with Na ions in a molten salt by chemical strengthening is small, and the Na ion profiles in the sheet thickness direction are flat. As shown in FIG. 1C and FIG. 1D, since the amount of exchange of Na ions is small, exchange of Na ions and K ions occurs only in a surface layer of an extremely shallow portion of the glass due to the chemical strengthening with a molten salt containing K, and a layer in which K ions are present is extremely thin, thereby obtaining a chemically strengthened glass in which an alkali mixing degree is reduced.

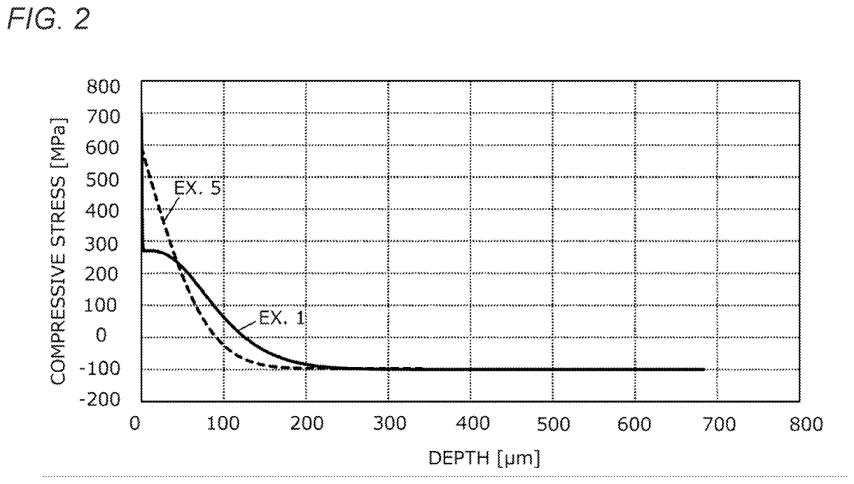

A stress profile in one embodiment of the present chemically strengthened glass is shown in FIG. 2 (Example 1). As shown in FIG. 2, although the present chemically strengthened glass is a glass having a low alkali mixing degree in a glass surface layer, a compressive stress in the glass surface layer is higher than that of a chemically strengthened glass in the related art, and the present chemically strengthened glass exhibits excellent strength.

The present chemically strengthened glass preferably has a surface compressive stress value (CS₀) of 450 MPa or more because the present chemically strengthened glass hardly breaks due to deformation such as deflection. CS₀ is more preferably 500 MPa or more, and still more preferably 600 MPa or more. The strength increases as CS₀ increases, but when CS₀ is too large, severe fracture may occur if the present chemically strengthened glass is broken. Therefore, CS₀ is preferably 1100 MPa or less, and more preferably 900 MPa or less.

The present chemically strengthened glass preferably has a compressive stress value (CS₅₀) at a depth of 50 μm from the surface of 150 MPa or more, because breakage of the present chemically strengthened glass is easily prevented when a mobile terminal or the like equipped with the present chemically strengthened glass as a cover glass is dropped. CS₅₀ is more preferably 180 MPa or more, and still more preferably 200 MPa or more. The strength increases as CS₅₀ increases, but when CS₅₀ is too large, severe fracture may occur if the present chemically strengthened glass is broken. Therefore, CS₅₀ is preferably 300 MPa or less, and more preferably 270 MPa or less.

In the present chemically strengthened glass, a value CS₅₀/(Na₅₀−Na_{t/2}) obtained by dividing the compressive stress value CS₅₀ at the depth of 50 μm from the surface by (Na₅₀−Na_{t/2}) is preferably 50 MPa/% or more, more preferably 55 MPa/% or more, and still more preferably 60 MPa/% or more. Since CS₅₀(Na₅₀−Na_{t/2}) is 50 MPa/% or more, excellent strength is exhibited. As CS₅₀/(Na₅₀−Na_{t/2}) increases, the strength can be increased without increasing surface resistance with a smaller amount of ion exchange. However, when the CS₅₀/(Na₅₀−Na_{t/2}) is too large, the present chemically strengthened glass is likely to be affected by deterioration of a strengthening salt, and thus CS₅₀/(Na₅₀−Na_{t/2}) is preferably 400 MPa/% or less, and more preferably 300 MPa/% or less. Na₅₀ indicates a Na₂O concentration [%] in terms of mole percentage based on oxides at the depth of 50 μm from the surface. Na_{t/2} refers to a content [%] of Na₂O in terms of mole percentage based on oxides before chemical strengthening.

The present chemically strengthened glass preferably has a compressive stress value CS₉₀ at a depth of 90 μm from the surface of 30 MPa or more, because breakage of the present chemically strengthened glass is prevented when a mobile terminal or the like equipped with the present chemically strengthened glass as a cover glass is dropped on coarse sand or the like. CS₉₀ is more preferably 50 MPa or more, and still more preferably 70 MPa or more. The strength increases as CS₉₀ increases, but when CS₉₀ is too large, severe fracture may occur if the present chemically strengthened glass is broken. Therefore, CS₉₀ is preferably 170 MPa or less, and more preferably 150 MPa or less.

The present chemically strengthened glass preferably has a compressive stress value CS_{t/2} at a depth t/2 from the surface of −120 MPa or more, more preferably −115 MPa or more, and still more preferably −110 MPa or more, where t is a sheet thickness. Since CS_{t/2} is −120 MPa or more, explosive breakage when the glass is damaged can be prevented. An upper limit of CS_{t/2} is not particularly limited, but is usually preferably −80 MPa or less in order to maintain a sufficient compressive stress.

The present chemically strengthened glass preferably has a DOL of 90 μm or more because the glass is less likely to break even when the surface is scratched. DOL is more preferably 95 μm or more, still more preferably 100 μm or more, and particularly preferably 110 μm or more. As DOL increases, the glass is less likely to break even when scratches are generated. However, in the chemically strengthened glass, a tensile stress is generated in the inside in accordance with a compressive stress formed in the vicinity of the surface, and thus it is not possible to extremely increase DOL. In the case of the thickness t, DOL is preferably t/4 or less, and more preferably t/5 or less. DOL is preferably 200 μm or less, and more preferably 180 μm or less in order to shorten the time required for chemical strengthening.

In the present chemically strengthened glass, since the stress value decreases under the influence of deterioration of the strengthening salt, each of CS₅₀ and CS₉₀ is preferably 70% or more of an initial strengthening value. That is, the surface compressive stress value CS₀ is preferably 450 MPa or more, the compressive stress value CS₅₀ at the depth of 50 μm from the surface is preferably y=124.7×t+21.5 [MPa] or more, and the compressive stress value CS₉₀ at the depth of 90 μm from the surface is preferably y=99.1×t−38.3 [MPa] or more.

In the present chemically strengthened glass, an inclination P₀ of a glass surface layer defined by a formula CS₀/D is preferably −1000 MPa/μm<P₀<−225 MPa/μm because a result of a 4PB strength (MPa) test exceeds 550 MPa. In the formula, CS₀ is a surface compressive stress value (MPa), and D is a K ion penetration depth (μm).

In addition, |P₅₀₋₉₀|>|P_{90-DOL}|, and 1.8<|P₅₀₋₉₀|<6.0 and 1.5<|P_{90-DOL}|<4.0 are preferably satisfied, where P₅₀₋₉₀ (MPa/μm) is an inclination of a stress profile of the chemically strengthened glass in a region between the depth of 50 μm from the surface and the depth of 90 μm from the surface, and P_{90-DOL} (MPa/μm) is an inclination of a stress profile of the chemically strengthened glass in a region between the depth of 90 μm from the surface and a depth (DOL) (μm) at which a compressive stress value is zero. As a more preferable aspect, an aspect in which |P₅₀₋₉₀|>|P_{90-DOL}|, and 1.8<|P₅₀₋₉₀|<6.0 and 1.5<|P_{90-DOL}|<4.0 are satisfied, and #180 drop strength is 100 cm or more is exemplified.
P₅₀₋₉₀ and P_{90-DOL} are calculated by the following formulas, respectively.

P₅₀₋₉₀=(CS₅₀-CS₉₀)/40

P_{90-DOL}=CS₉₀/(DOL−90)

Furthermore, |P₅₀₋₉₀|<|P_{90-DOL}|, and 1.0<|P₅₀₋₉₀|<3.0 and 1.2<|P_{90-DOL}|<4.0 are preferably satisfied, where P₅₀₋₉₀ is the inclination of the stress profile of the chemically strengthened glass in the region between the depth of 50 μm from the surface and the depth of 90 μm from the surface, and P_{90-DOL} (MPa/μm) is the inclination of the stress profile of the chemically strengthened glass in the region between the depth of 90 μm from the surface and the depth (DOL) (μm) at which a compressive stress value is zero. As a more preferable aspect, |P₅₀₋₉₀|<|P_{90-DOL}|, and 1.0<|P₅₀₋₉₀|<3.0 and 1.2<P_{90-DOL}|<4.0 are satisfied, and #80 drop strength is preferably 40 cm or more.

In Embodiment 1, a preferred range of the sheet thickness t of the present chemically strengthened glass is 300 μm to 1500 μm.

### Embodiment 2

Embodiment 2 of the present chemically strengthened glass is a chemically strengthened glass in which a K ion penetration depth D is 0.5 μm to 5 μm, an absolute value of a difference between a compressive stress value at the depth D and a compressive stress value CS₅₀ at a depth of 50 μm from a surface is 150 MPa or less, the compressive stress value at the K ion penetration depth D is 350 MPa or less, a surface compressive stress value CS₀ is 450 MPa or more, the compressive stress value CS₅₀ at the depth of 50 μm from the surface is 150 MPa or more, and a compressive stress value CS₉₀ at a depth of 90 μm from the surface is 30 MPa or more.

In Embodiment 2 of the present chemically strengthened glass, since the K ion penetration depth D is 0.5 μm to 5 μm, an alkali mixing degree on the glass surface becomes low, and an increase in surface resistivity can be prevented. D is preferably 0.7 μm to 4 μm, and more preferably 0.8 μm to 3 μm.

In Embodiment 2 of the present chemically strengthened glass, the absolute value of the difference between the compressive stress value at the K ion penetration depth D and the compressive stress value CS₅₀ at the depth of 50 μm from the surface is 150 MPa or less, and thus breakage due to deformation such as deflection can be prevented. The absolute value of the difference between the compressive stress value at the K ion penetration depth D and the compressive stress value CS₅₀ at the depth of 50 μm from the surface is preferably 130 MPa or less, and more preferably 110 MPa or less. A lower limit of the absolute value of the difference between the compressive stress value at the depth D and the compressive stress value CS₅₀ at the depth of 50 μm from the surface is not particularly limited.

In Embodiment 2 of the present chemically strengthened glass, the compressive stress value at the K ion penetration depth D is 350 MPa or less, and thus CS₅₀ and CS₉₀ can be sufficiently increased without excessively increasing CT. The compressive stress value at the K ion penetration depth D is preferably 330 MPa or less, and more preferably 300 MPa or less. A lower limit of the compressive stress value at the K ion penetration depth D is not particularly limited, but is preferably 100 MPa or more from the viewpoint of preventing cracks in the vicinity of the surface.

<<Surface Resistance>>

The present chemically strengthened glass preferably has a surface resistance log ρ of 12 Ω·cm or less, more preferably 11.5 Ω·cm or less, and still more preferably 11 Ω·cm or less. Since the surface resistance log ρ is 12 Ω·cm or less, peeling of a coating film can be prevented. A lower limit of the surface resistance log ρ is not particularly limited, but is typically 8 Ω·cm or more.

<<Drop Strength>>

The present chemically strengthened glass preferably has #180 drop strength of 100 cm or more, more preferably 140 cm or more, and still more preferably 180 cm or more. Since the #180 drop strength is 100 cm or more, breakage of the present chemically strengthened glass can be prevented when a mobile terminal or the like equipped with the present chemically strengthened glass as a cover glass is dropped on sand or the like. An upper limit of the #180 drop strength is not particularly limited, but is typically 300 cm or less.

The present chemically strengthened glass preferably has #80 drop strength of 40 cm or more, more preferably 50 cm or more, and still more preferably 60 cm or more. Since the #80 drop strength is 40 cm or more, breakage of the present chemically strengthened glass can be prevented when a mobile terminal or the like equipped with the present chemically strengthened glass as a cover glass is dropped on coarse sand or the like. An upper limit of the #80 drop strength is not particularly limited, but is typically 150 cm or less.

In Embodiment 2, a preferred range of the sheet thickness t of the present chemically strengthened glass is 300 μm to 1500 μm.

<<AFP Durability>>

The present chemically strengthened glass preferably has AFP durability (10000 times) of 100 degrees or more, more preferably 105 degrees or more, and still more preferably 110 degrees or more. Since the AFP durability (10000 times) is 100 degrees or more, peeling of a coating film can be prevented. An upper limit of the AFP durability (10000 times) is not particularly limited, but is typically 125 degrees or less.

<<Usage>>

The present chemically strengthened glass is also useful as a cover glass used in an electronic device such as a mobile device such as a mobile phone or a smartphone. Furthermore, the present strengthened glass is also useful for a cover glass of an electronic device such as a television, a personal computer, and a touch panel, an elevator wall surface, or a wall surface (full-screen display) of a construction such as a house and a building, which is not intended to be carried. In addition, the present strengthened glass is also useful as a building material such as a window glass, a table top, an interior of an automobile, an airplane, or the like, and a cover glass thereof, or a casing having a curved surface shape.

An ion profile and stress characteristics of the present chemically strengthened glass can be adjusted by a base composition of the present chemically strengthened glass and conditions of the chemical strengthening treatment. From the viewpoint of improving the stress characteristics of the present chemically strengthened glass, the present chemically strengthened glass is preferably a glass ceramic. Hereinafter, the base composition of the present chemically strengthened glass and the glass ceramics will be described.

<<Base Composition of Present Chemically Strengthened Glass>>

A base composition of the present chemically strengthened glass preferably contains SiO₂, Li₂O, and Al₂O₃. The base composition of the present chemically strengthened glass preferably contains, in terms of mol % based on oxides:
40% to 75% of SiO₂;
5% to 35% of Li₂O; and
1% to 20% of Al₂O₃.

More preferably, the base composition contains:
40% to 70% of SiO₂;
5% to 35% of Li₂O; and
1% to 20% of Al₂O₃.

Still more preferably, the base composition contains:
50% to 70% of SiO₂;
10% to 30% of Li₂O;
1% to 15% of Al₂O₃;
0% to 5% of P₂O₅;
0% to 8% of ZrO₂;
0% to 10% of MgO;
0% to 5% of Y₂O₃;
0% to 10% of B₂O₃;
0% to 5% of Na₂O;
0% to 5% of K₂O; and
0% to 2% of SnO₂.

Specifically, for example, the following glasses (i) to (iii) are preferable.
(i) A glass containing 61.0% of SiO₂, 21.0% of Li₂O, 5.0% of Al₂O₃, 2.0% of Na₂O, 2.0% of P₂O₅, 3.0% of ZrO₂, 5.0% of MgO, and 1.0% of Y₂O₃.
(ii) A glass containing 51.2% of SiO₂, 34.1% of Li₂O, 5.0% of Al₂O₃, 1.8% of Na₂O, 2.3% of P₂O₅, 4.5% of ZrO₂, and 1.0% of Y₂O₃.
(iii) A glass containing 54.0% of SiO₂, 30.9% of Li₂O, 5.4% of Al₂O₃, 1.7% of Na₂O, 1.2% of K₂O, 1.9% of P₂O₅, 3.9% of ZrO₂, and 0.7% of Y₂O₃.

In addition, impurities such as Sb₂O₃ and HfO₂ may be contained as trace components.

Here, the “base composition of the chemically strengthened glass” refers to a composition of glass ceramics before chemical strengthening. The composition will be described later. A composition of the present chemically strengthened glass has a composition similar to that of the glass ceramics before strengthening as a whole except for a case where an extreme ion exchange treatment is performed, and usually, the composition of the glass ceramics before strengthening is equivalent to the composition of the chemically strengthened glass at the center of the sheet thickness. In particular, a composition of a deepest portion from the glass surface is the same as the composition of the glass ceramics before strengthening, except for the case where the extreme ion exchange treatment is performed.

<Glass Ceramics>

The present chemically strengthened glass preferably contains glass ceramics (hereinafter, also referred to as the present glass ceramics) from the viewpoint of increasing strength. The glass ceramics have excellent strength compared to an amorphous glass, and thus a preferable stress profile is easily formed, and both the strength and surface properties of the glass are easily achieved even in a case where the alkali mixing degree of the glass surface is low compared to the chemically strengthened glass in the related art.

Examples of crystals contained in the glass ceramics include lithium phosphate crystals, lithium metasilicate crystals, and β-spodumene crystals. Among them, the lithium phosphate crystals and the lithium metasilicate crystals are preferable from the viewpoint of increasing the strength. The crystals contained in the glass ceramics may be solid solution crystals. By containing such crystals, the strength is improved, the light transmittance is increased, and the haze is reduced.

Li₃PO₄ crystals and Li₄SiO₄ crystals have similar crystal structures, and thus it may be difficult to distinguish between the Li₃PO₄ crystals and the Li₄SiO₄ crystals by powder X-ray diffraction measurement. That is, when powder X-ray diffraction is measured, diffraction peaks appear near 2θ=16.9°, 22.3°, 23.1° and 33.9°. Since the amount of crystals may be small or the crystals may be oriented, a peak having low intensity or a peak of a specific crystal plane may not be observed. In a case where both crystals are in solid solution, a peak position may be shifted by about 1° in 2θ.

In the present glass ceramics, when X-ray diffraction is measured in a range of 2θ=10° to 80°, the largest diffraction peak preferably appears at 22.3°±0.2 or 23.1°±0.2.

A crystallization rate of the present glass ceramics is preferably 5% or more, more preferably 10% or more, still more preferably 15% or more, and particularly preferably 20% or more in order to increase mechanical strength. In order to enhance transparency, the crystallization rate is preferably 70% or less, more preferably 60% or less, and still more preferably 50% or less. The low crystallization rate is also excellent in that the glass can be easily bent by heating.

An average grain size of precipitated crystals of the present glass ceramics is preferably 5 nm or more, and particularly preferably 10 nm or more in order to increase strength. In order to enhance transparency, the average grain size is preferably 80 nm or less, more preferably 60 nm or less, still more preferably 50 nm or less, particularly preferably 40 nm or less, and most preferably 30 nm or less. The average grain size of the precipitated crystals is determined from a transmission electron microscope (TEM) image.

In a case where the present glass ceramics are sheet-shaped, a thickness (t) thereof is preferably 3000 μm or less, more preferably 2000 μm or less, 1600 μm or less, 1100 μm or less, 900 μm or less, 800 μm or less, or 700 μm or less in a stepwise manner. In order to obtain sufficient strength by the chemical strengthening treatment, the thickness (t) is preferably 300 μm or more, more preferably 400 μm or more, and still more preferably 500 μm or more.

Light transmittance of the present glass ceramics is 85% or more in terms of a thickness of 700 μm, and thus a screen of a display can be easily seen when the present glass ceramics are used as a cover glass of a portable display. The light transmittance is preferably 88% or more, and more preferably 90% or more. The light transmittance is preferably as high as possible, but is usually 91% or less. When the thickness is 700 μm, the light transmittance of 90% is equivalent to that of an ordinary amorphous glass.

When an actual thickness is not 700 μm, the light transmittance in the case of 700 μm can be calculated from the Lambert-Beer law based on a measured value. When the sheet thickness t is larger than 700 μm, the sheet thickness may be adjusted to 700 μm by polishing, etching, or the like.

When the thickness is 700 μm, a haze value is 0.5% or less, preferably 0.4% or less, more preferably 0.3% or less, still more preferably 0.2% or less, and particularly preferably 0.15% or less. The haze value is preferably as small as possible, but is usually 0.01% or more. When the thickness is 700 μm, a haze value of 0.02% is equivalent to that of an ordinary amorphous glass.

In a case where total visible light transmittance of the glass ceramics having the sheet thickness t [μm] is 100×T [%] and the haze value is 100×H [%], T=(1−R)2×exp(−αt) can be described using a constant α by incorporating the Lambert-Beer law. Using the constant α, dH/dt∝exp(−αt)×(1−H) can be obtained.

That is, the haze value is considered to increase by an amount proportional to internal linear transmittance as the sheet thickness increases, and thus the haze value H_{0.7} in the case of 700 μm is calculated by the following formula.

H_{0.7}=100×[1−(1−H)^{{((1-R)2-T0.7)/((1-R)2-T)}}][%]

When the sheet thickness t is larger than 700 μm, the sheet thickness may be adjusted to 700 μm by polishing, etching, or the like.

The present glass ceramics has a high fracture toughness value, and is less likely to cause severe fracture even when a large compressive stress is formed by chemical strengthening. When the fracture toughness value of the present glass ceramics is preferably 0.81 MPa·m^{1/2} or more, more preferably 0.84 MPa·m^{1/2} or more, and still more preferably 0.87 MPa·m^{1/2} or more, a glass having high impact resistance can be obtained. An upper limit of the fracture toughness value of the present glass ceramics is not particularly limited, but is typically 1.5 MPa·m^{1/2} or less.

A Young's modulus of the present glass ceramics is preferably 80 GPa or more, more preferably 85 GPa or more, still more preferably 90 GPa or more, particularly preferably 95 GPa or more in order to prevent warpage during chemical strengthening treatment. The present glass ceramics may be used after being polished. For ease of polishing, the Young's modulus is preferably 130 GPa or less, more preferably 120 GPa or less, and still more preferably 110 GPa or less.

The present glass ceramics are obtained by subjecting an amorphous glass to be described later to a heat treatment for crystallization.

<<Composition of Glass Ceramics>>

The present glass ceramics preferably contain SiO₂, Li₂O, and Al₂O₃. The present glass ceramics contain, in terms of mol % based on oxides:
40% to 75% of SiO₂;
5% to 35% of Li₂O; and
1% to 20% of Al₂O₃.

More preferably, the present glass ceramics contain:
40% to 70% of SiO₂;
5% to 35% of Li₂O; and
1% to 20% of Al₂O₃.

Still more preferably, the present glass ceramics contain, in terms of mol % based on oxides:
50% to 70% of SiO₂;
10% to 30% of Li₂O;
1% to 15% of Al₂O₃;
0% to 5% of P₂O;
0% to 8% of ZrO₂;
0% to 10% of MgO;
0% to 5% of Y₂O₃;
0% to 10% of B₂O₃;
0% to 5% of Na₂O;
0% to 5% of K₂O; and
0% to 2% of SnO₂.

Specifically, for example, the following glasses (i) to (iii) are preferable.
(i) A glass containing 61.0% of SiO₂, 21.0% of Li₂O, 5.0% of Al₂O₃, 2.0% of Na₂O, 2.0% of P₂O₅, 3.0% of ZrO₂, 5.0% of MgO, and 1.0% of Y₂O₃.
(ii) A glass containing 51.2% of SiO₂, 34.1% of Li₂O, 5.0% of Al₂O₃, 1.8% of Na₂O, 2.3% of P₂O₅, 4.5% of ZrO₂, and 1.0% of Y₂O₃.
(iii) A glass containing 54.0% of SiO₂, 30.9% of Li₂O, 5.4% of Al₂O₃, 1.7% of Na₂O, 1.2% of K₂O, 1.9% of P₂O₅, 3.9% of ZrO₂, and 0.7% of Y₂O₃.

In addition, impurities such as Sb₂O₃ and HfO₂ may be contained as trace components.

In the present glass ceramics, a total amount of SiO₂, Al₂O₃, P₂O₅, and B₂O₃ is preferably 60% to 80% in terms of mol % based on oxides. SiO₂, Al₂O₃, P₂O₅, and B₂O₃ are network formers of the glass (hereinafter abbreviated as NWF). When the total amount of NWF is large, the strength of the glass is increased. Accordingly, since the fracture toughness value of the glass ceramics is increased, the total amount of NWF is preferably 60% or more, more preferably 63% or more, and particularly preferably 65% or more. However, a glass with too much NWF has a high melting temperature, which makes it difficult to produce a glass, and thus the total amount of NWF is preferably 85% or less, more preferably 80% or less, and still more preferably 75% or less.

In the present glass ceramics, a ratio of the total amount of LiO, Na₂O, and K₂O to the total amount of NWF, that is, SiO₂, Al₂O₃, P₂O₅, and B₂O₃ is preferably 0.20 to 0.60.

Li₂O, Na₂O, and K₂O are network-modifier, and decreasing the ratio to NWF increases gaps in the network, thereby improving impact resistance. Therefore, NWF is preferably 0.60 or less, more preferably 0.55 or less, and particularly preferably 0.50 or less. Further, these are components necessary for chemical strengthening, and thus NWF is preferably 0.20 or more, more preferably 0.25 or more, and particularly preferably 0.30 or more in order to improve chemical strengthening properties.

The composition of the present glass ceramics will be described below.

In the present glass ceramics, SiO₂ is a component for forming a glass network structure. In addition, SiO₂ is a component for increasing chemical durability, and a content of SiO₂ is preferably 40% or more. The content of SiO₂ is more preferably 48% or more, still more preferably 50% or more, particularly preferably 52% or more, and extremely preferably 54% or more. Further, in order to improve meltability, the content of SiO₂ is preferably 75% or less, more preferably 70% or less, still more preferably 68% or less, yet still more preferably 66% or less, and particularly preferably 64% or less.

Li₂O is a component for forming a surface compressive stress by ion exchange, a component of a main crystal, and is essential. A content of Li₂O is preferably 5% or more, more preferably 8% or more, more preferably 11% or more, still more preferably 15% or more, particularly preferably 20% or more, and most preferably 22% or more. Further, in order to stabilize the glass, the content of Li₂O is preferably 35% or less, more preferably 32% or less, still more preferably 30% or less, particularly preferably 28% or less, and most preferably 26% or less.

Al₂O₃ is a component for increasing a surface compressive stress by chemical strengthening, and is essential. A content of Al₂O₃ is preferably 1% or more, more preferably 2% or more, still more preferably 3% or more, 5% or more, 5.5% or more, and 6% or more in this order, particularly preferably 6.5% or more, and most preferably 7% or more. Further, the content of Al₂O₃ is preferably 20% or less, more preferably 15% or less, still more preferably 12% or less, particularly preferably 10% or less, and most preferably 9% or less in order to prevent the glass from having an excessively high devitrification temperature.

P₂O₅ is a constituent of a Li₃PO₄ crystal, and is essential when the crystal is precipitated. In this case, a content of P₂O₅ is preferably 0.5% or more, more preferably 1% or more, still more preferably 1.5% or more, particularly preferably 2% or more, and extremely preferably 2.5% or more in order to promote crystallization. Further, when the content of P₂O₅ is too large, phase separation is likely to occur during melting and acid resistance is significantly reduced, and thus the content of P₂O₅ is preferably 5% or less, more preferably 4.8% or less, still more preferably 4.5% or less, and particularly preferably 4.2% or less.

ZrO₂ is a component for enhancing mechanical strength and chemical durability, and is preferably contained in order to remarkably improve CS. A content of ZrO₂ is preferably 0.5% or more, more preferably 1% or more, still more preferably 1.5% or more, particularly preferably 2% or more, and most preferably 2.5% or more. Further, in order to prevent devitrification during melting, the content of ZrO₂ is preferably 8% or less, more preferably 7.5% or less, and particularly preferably 6% or less. When the content of ZrO₂ is too large, viscosity is further decreased due to an increase in devitrification temperature. In order to prevent deterioration of moldability due to such a decrease in viscosity, when the molding viscosity is low, the content of ZrO₂ is preferably 5% or less, more preferably 4.5% or less, and still more preferably 3.5% or less.

MgO is a component for stabilizing a glass and also a component for enhancing mechanical strength and chemical resistance, and thus MgO is preferably contained when the content of Al₂O₃ is relatively low, for example. A content of MgO is preferably 1% or more, more preferably 2% or more, still more preferably 3% or more, and particularly preferably 4% or more. Further, when MgO is excessively added, the viscosity of the glass decreases, and the devitrification or the phase separation easily occurs. Therefore, the content of MgO is preferably 10% or less, more preferably 9% or less, still more preferably 8% or less, and particularly preferably 7% or less.

Y₂O₃ is a component having an effect of preventing broken pieces from scattering when the chemically strengthened glass is broken, and may be contained. A content of Y₂O₃ is preferably 1% or more, more preferably 1.5% or more, still more preferably 2% or more, particularly preferably 2.5% or more, and extremely preferably 3% or more. Further, in order to prevent devitrification during melting, the content of Y₂O₃ is preferably 5% or less, and more preferably 4% or less.

B₂O₃ is a component for improving chipping resistance and meltability of the glass for chemical strengthening or the chemically strengthened glass, and may be contained. A content of B₂O₃ when contained is preferably 0.5% or more, more preferably 1% or more, and still more preferably 2% or more in order to improve meltability. Further, when the content of B₂O₃ is too large, striae are generated during melting, and the phase separation is likely to occur, resulting in a deterioration in the quality of the glass for chemical strengthening, and thus, the content is preferably 10% or less. The content of B₂O₃ is more preferably 8% or less, still more preferably 6% or less, and particularly preferably 4% or less.

Na₂O is a component for improving meltability of a glass. Na₂O is not essential, but is preferably 0.5% or more, more preferably 1% or more, and particularly preferably 2% or more when contained. When Na₂O is too large, crystals such as Li₃PO₄, which are main crystals, are less likely to be precipitated, or chemical strengthening properties are deteriorated. Therefore, a content of Na₂O is preferably 5% or less, more preferably 4.5% or less, still more preferably 4% or less, and particularly preferably 3.5% or less.

K₂O, like Na₂O, is a component for lowering a melting temperature of the glass, and may be contained. A content of K₂O when contained is preferably 0.5% or more, more preferably 1% or more, still more preferably 1.5% or more, and particularly preferably 2% or more. When the content of K₂O is too large, the chemical strengthening properties are deteriorated, or the chemical durability is deteriorated. Therefore, the content of K₂O is preferably 5% or less, more preferably 4% or less, still more preferably 3.5% or less, particularly preferably 3% or less, and most preferably 2.5% or less.

A total content of Na₂O and K₂O, Na₂O+K₂O, is preferably 1% or more, and more preferably 2% or more in order to improve meltability of a glass raw material.

In addition, a ratio K₂O/R₂O of the content of K₂O to a total content of LiO, Na₂O, and K₂O (hereinafter, referred to as R₂O) is preferably 0.2 or less because the chemical strengthening properties can be enhanced, and the chemical durability can be enhanced. K₂O/R₂O is more preferably 0.15 or less, and still more preferably 0.10 or less.

R₂O is preferably 10% or more, more preferably 15% or more, and still more preferably 20% or more. Further, R₂O is preferably 29% or less, and more preferably 26% or less.

Further, in order to increase chemical durability, ZrO₂/R₂O is preferably 0.02 or more, more preferably 0.03 or more, still more preferably 0.04 or more, particularly preferably 0.1 or more, and most preferably 0.15 or more. In order to increase transparency after crystallization, ZrO₂/R₂O is preferably 0.6 or less, more preferably 0.5 or less, still more preferably 0.4 or less, and particularly preferably 0.3 or less.

SnO₂ has an effect of promoting formation of crystal nuclei, and may be contained. SnO₂ is not essential, but a content of SnO₂ when contained is preferably 0.5% or more, more preferably 1% or more, still more preferably 1.5% or more, and particularly preferably 2% or more. Further, in order to prevent devitrification during melting, the content of SnO₂ is preferably 5% or less, more preferably 4% or less, still more preferably 3.5% or less, and particularly preferably 3% or less.

TiO₂ is a component capable of promoting crystallization, and may be contained. TiO₂ is not essential, but a content of TiO₂ when contained is preferably 0.2% or more, and more preferably 0.5% or more. Further, in order to prevent devitrification during melting, the content of TiO₂ is preferably 4% or less, more preferably 2% or less, and still more preferably 1% or less.

BaO, SrO, MgO, CaO, and ZnO are components for improving meltability of a glass and may be contained. When these components are contained, a total content of BaO, SrO, MgO, CaO and ZnO (hereinafter referred to as BaO+SrO+MgO+CaO+ZnO) is preferably 0.5% or more, more preferably 1% or more, still more preferably 1.5% or more, and particularly preferably 2% or more. Further, since an ion exchange rate decreases. BaO+SrO+MgO+CaO+ZnO is preferably 8% or less, more preferably 6% or less, still more preferably 5% or less, and particularly preferably 4% or less.

Of these, BaO, SrO, and ZnO may be contained in order to improve a refractive index of a residual glass to be close to a precipitated crystal phase, thereby improving the light transmittance of the glass ceramics to decrease the haze value. In this case, a total content of BaO, SrO, and ZnO (hereinafter referred to as BaO+SrO+ZnO) is preferably 0.3% or more, more preferably 0.5% or more, still more preferably 0.7% or more, and particularly preferably 1% or more. Further, these components may reduce the ion exchange rate. In order to improve the chemical strengthening properties, BaO+SrO+ZnO is preferably 2.5% or less, more preferably 2% or less, still more preferably 1.7% or less, and particularly preferably 1.5% or less.

La₂O₃, Nb₂O₅, and Ta₂O₅ are all components that prevent broken pieces from scattering when the chemically strengthened glass is broken, and may be contained in order to increase a refractive index. When these components are contained, a total content of La₂O₃. Nb₂O₅, and Ta₂O₅ (hereinafter, referred to as La₂O₃+Nb₂O₅+Ta₂O₅) is preferably 0.5% or more, more preferably 1% or more, still more preferably 1.5% or more, and particularly preferably 2% or more. Further, in order to prevent devitrification of the glass during melting, La₂O₃+Nb₂O₅+Ta₂O₅ is preferably 4% or less, more preferably 3% or less, still more preferably 2% or less, and particularly preferably 1% or less.

Further, CeO₂ may be contained. CeO₂ may prevent coloration by oxidizing a glass. A content of CeO₂ when contained is preferably 0.03% or more, more preferably 0.05% or more, and still more preferably 0.07% or more. In order to increase transparency, the content of CeO₂ is preferably 1.5% or less, and more preferably 1.0% or less.

When the present chemically strengthened glass is used by coloring, a coloring component may be added as long as achievement of desired chemical strengthening properties is not inhibited. Examples of the coloring component include Co₃O₄, MnO₂, Fe₂O₃, NiO, CuO, Cr₂O₃, V₂O₅, Bi₂O₃, SeO₂, Er₂O₃, and Nd₂O₃.

A total content of the coloring components is preferably 1% or less. In a case where it is desired to further increase visible light transmittance of the glass, it is preferable that these components are not substantially contained.

SO₃, a chloride, and a fluoride may be appropriately contained as a refining agent or the like during melting of the glass. As₂O₃ is preferably not contained. In a case where Sb₂O₃ is contained, the content thereof is preferably 0.3% or less, and more preferably 0.1% or less, and it is most preferable that Sb₂O₃ is not contained.

<Method for Producing Chemically Strengthened Glass>

The chemically strengthened glass of the present invention is produced by chemically strengthening the glass ceramics described above. The glass ceramics are produced by a method in which an amorphous glass having the same composition is crystallized by heat treatment.

(Production of Amorphous Glass)

An amorphous glass can be produced, for example, by the following method. The production method described below is an example of producing a sheet-shaped chemically strengthened glass.

In order to obtain a glass having a preferred composition, glass raw materials are blended, and then heated and melted in a glass melting furnace. Thereafter, the molten glass is homogenized by bubbling, stirring, addition of a refining agent, or the like and formed into a glass sheet having a predetermined thickness by a known forming method, followed by being annealed. Alternatively, the molten glass may be formed into a block shape, annealed, and then cut into a sheet shape.

(Crystallization Treatment)

The amorphous glass obtained by the above procedure is subjected to a heat treatment to obtain glass ceramics.

The heat treatment may be a two-stage heat treatment in which the glass is held for a certain period of time at a temperature raised from room temperature to a first treatment temperature, and then is held for a certain period of time at a second treatment temperature that is higher than the first treatment temperature. Alternatively, the heat treatment may be a one-stage heat treatment in which the glass is held at a specific treatment temperature and then cooled to room temperature.

In the case of the two-stage heat treatment, the first treatment temperature is preferably a temperature range in which a crystal nucleation rate increases in the glass composition, and the second treatment temperature is preferably a temperature range in which a crystal growth rate increases in the glass composition. A holding time at the first treatment temperature is preferably kept long so that a sufficient number of crystal nuclei are generated. When a large number of crystal nuclei are generated, a size of each crystal is reduced, and glass ceramics having high transparency are obtained.

In the case of the two-stage treatment, for example, the glass is held at the first treatment temperature of 450° C. to 700° C. for 1 hour to 6 hours, and then held at the second treatment temperature of 600° C. to 800° C. for 1 hour to 6 hours. In the case of one-stage treatment, for example, the glass is held at 500° C. to 800° C. for 1 hour to 6 hours.

The glass ceramics obtained by the above procedure is subjected to grinding and polishing as necessary to form a glass ceramic sheet. If the glass ceramic sheet is cut into a predetermined shape and size or subjected to chamfering, it is preferable to cut the glass ceramic sheet, or perform chamfering before the chemical strengthening treatment is performed, because a compressive stress layer is also formed on an end surface by a subsequent chemical strengthening treatment.

(Chemical Strengthening Treatment)

The chemical strengthening treatment is a treatment in which, by a method of immersing the glass into a melt of a metal salt (for example, potassium nitrate) containing metal ions (typically, Na ions or K ions) having a large ionic radius, the glass is brought into contact with the metal salt, and thus metal ions having a small ionic radius (typically, Na ions or Li ions) in the glass are substituted with the metal ions having a large ionic radius (typically, Na ions or K ions for Li ions, and K ions for Na ions).

In order to increase a rate of the chemical strengthening treatment, it is preferable to use “Li—Na exchange” in which Li ions in the glass are exchanged with Na ions. In addition, in order to form a large compressive stress by ion exchange, it is preferable to use “Na—K exchange” in which Na ions in the glass are exchanged with K ions.

Examples of the molten salt for performing the chemical strengthening treatment include a nitrate, a sulfate, a carbonate, a chloride, and the like. Examples of the nitrate include lithium nitrate, sodium nitrate, potassium nitrate, cesium nitrate, silver nitrate, and the like. Examples of the sulfate include lithium sulfate, sodium sulfate, potassium sulfate, cesium sulfate, silver sulfate, and the like. Examples of the carbonate include lithium carbonate, sodium carbonate, potassium carbonate, and the like. Examples of the chloride include lithium chloride, sodium chloride, potassium chloride, cesium chloride, silver chloride, and the like. These molten salts may be used alone or in combination.

As the treatment conditions of the chemical strengthening treatment, time, temperature, and the like may be selected in consideration of the glass composition, the type of molten salt, and the like. For example, the present glass ceramics are preferably subjected to a chemical strengthening treatment at 450° C. or less for preferably 1 hour or less. Specifically, for example, a treatment of immersing the present glass ceramics in a molten salt (for example, a mixed salt of lithium nitrate and sodium nitrate) containing 0.3 mass % of Li and 99.7 mass % Na preferably at 450° C. for preferably about 0.5 hours is exemplified.

The chemical strengthening treatment may be performed by two or more stages of ion exchange. The two-stage ion exchange is specifically performed, for example, as follows. First, the present glass ceramics are immersed in a metal salt (for example, sodium nitrate) containing Na ions preferably at about 350° C. to 500° C. for preferably about 0.1 to 10 hours. This causes ion exchange between Li ions in the glass ceramics and Na ions in the metal salt, thereby forming a relatively deep compressive stress layer.

When a compressive stress layer is formed on a surface portion of a glass article by the chemical strengthening treatment, a tensile stress corresponding to a total amount of compressive stress of the surface is inevitably generated in a center portion of the glass article. If the tensile stress value becomes too large, when the glass article is cracked, the glass article breaks violently and broken pieces are scattered. When CT exceeds a threshold value (hereinafter, also referred to as CT limit), the number of broken pieces at the time of damage increases explosively. When two or more stages of ion exchange are performed, a maximum tensile stress value of a stress profile formed inside the glass by initial ion exchange (first ion exchange) is preferably larger than the CT limit. When the maximum tensile stress value after the first ion exchange is larger than the CT limit, the compressive stress is sufficiently introduced by the first ion exchange, and in the subsequent second ion exchange process, CS₅₀ and CS₉₀ can be kept high even after a stress value of the glass surface layer is reduced.

The CT limit is determined by the following formula (1). CTA corresponds to the CT limit and is a value determined by a composition of the glass for chemical strengthening. CTave is a value corresponding to an average value of the tensile stress, and CTave is determined by the following formula (2). If CTave<CTA, CTave is below the CT limit, and an explosive increase in the number of broken pieces at the time of damage can be prevented.

[Math. 3]

CTA=317.93×K1c/\sqrt{t}+228.5×t−398 Formula (1)
t: sheet thickness (μm)
K1c: fracture toughness value (MPa·m^{1/2})

CTave=ICT/L_{CT} Formula (2)
ICT: integral value of tensile stress (Pa·m)
L_{CT}: length (μm) in sheet thickness direction of tensile stress region

Next, the present glass ceramics are immersed in a metal salt (for example, potassium nitrate) containing K ions preferably at about 350° C. to 500° C. for preferably about 0.1 to 10 hours. Accordingly, a large compressive stress is generated in a portion of the compressive stress layer formed in the previous process, for example, within a depth of about 10 μm. By such a two-stage treatment, a stress profile having a large surface compressive stress value is easily obtained.

As described above, the followings are disclosed in the present specification.
1. A chemically strengthened glass having a thickness of t [μm] and including Li₂O, K₂O, and Na₂O, in which
a minimum depth z at which Kₓ is (K_{t/2}+0.1) [%] or more is 0.5 μm to 5 μm, provided that Kₓ [%] is a concentration of K₂O at a depth of x [μm] from a surface of the chemically strengthened glass and K_{t/2} [%] is a content of K₂O before chemical strengthening, in terms of mole percentage based on oxides.
2. The chemically strengthened glass according to above 1, in which
   |Na_{z}−Na₅₀|<3 [%] is satisfied, provided that Na_{z} [%] is a concentration of Na₂O at the minimum depth z [μm] at which Kₓ is (K_{t/2}+0.1) [%] or more where Kₓ [%] is the concentration of K₂O at the depth of x [μm] from the surface of the chemically strengthened glass and K_{t/2}[%] is the content of K₂O before chemical strengthening, and Na₅₀ [%] is a concentration of Na₂O at a depth of 50 μm from the surface of the chemically strengthened glass, in terms of mole percentage based on oxides.
3. The chemically strengthened glass according to above 1, in which
Na₅₀<Na_{t/2}+7 [%] is satisfied, provided that Na₅₀ [%] is a concentration of Na₂O at a depth of 50 μm from the surface of the chemically strengthened glass and Na_{t/2} [%] is a content of Na₂O before chemical strengthening, in terms of mole percentage based on oxides.
4. The chemically strengthened glass according to any one of above 1 to 3, in which
(Li_{t/2}+Na_{t/2}+K_{t/2})−2(Na₁+K₁)>0 [%] is satisfied, provided that K₁[%] is a concentration of K₂O at a depth of 1 μm from the surface of the chemically strengthened glass, Na₁ [%] is a concentration of Na₂O at a depth of 1 μm from the surface of the chemically strengthened glass, and Li_{t/2} [%], Na_{t/2} [%], and K_{t/2} [%] are contents of Li₂O, Na₂O, and K₂O before chemical strengthening, respectively, in terms of mole percentage based on oxides.
5. The chemically strengthened glass according to any one of above 1 to 4, having a surface compressive stress value CS₀ of 450 MPa or more, a compressive stress value CS₅₀ at a depth of 50 μm from the surface of the chemically strengthened glass of 150 MPa or more, and a compressive stress value CS₉₀ at a depth of 90 μm from the surface of the chemically strengthened glass of 30 MPa or more.
6. The chemically strengthened glass according to any one of above 1 to 4, having a surface compressive stress value CS₀ of 450 MPa or more, a compressive stress value CS₅₀ at a depth of 50 μm from the surface of the chemically strengthened glass of y=124.7×t+21.5 [MPa] or more, and a compressive stress value CS₉₀ at a depth of 90 μm from the surface of the chemically strengthened glass of y=99.1×t−38.3 [MPa] or more.
7. A chemically strengthened glass, in which
a K ion penetration depth D is 0.5 μm to 5 μm,
an absolute value of a difference between a compressive stress value at the K ion penetration depth D and a compressive stress value CS₅₀ at a depth of 50 μm from a surface of the chemically strengthened glass is 150 MPa or less,
the compressive stress value at the K ion penetration depth D is 350 MPa or less, and
a surface compressive stress value CS₀ is 450 MPa or more, the compressive stress value CS₅₀ at the depth of 50 μm from the surface of the chemically strengthened glass is 150 MPa or more, and a compressive stress value CS₉₀ at a depth of 90 μm from the surface of the chemically strengthened glass is 30 MPa or more.
8. The chemically strengthened glass according to any one of above 1 to 7, including a glass ceramic.
9. The chemically strengthened glass according to any one of above 1 to 8, having a base composition including 40% to 75% of SiO₂, 1% to 20% of Al₂O₃, and 5% to 35% of Li₂O in terms of mole percentage based on oxides.
10. The chemically strengthened glass according to any one of above 1 to 9, which is subjected to two or more stages of ion exchange, in which
CTave after first ion exchange, which is initial ion exchange, is larger than CTA, provided that the CTA is calculated by the following Formula (1), and the CTave is calculated by the following Formula (2).

[Math. 4]

CTA=317.93×K1c/\sqrt{t}+228.5×t−398 Formula (1)
t: sheet thickness (μm)
K1c: fracture toughness value (MPa·m^{1/2})

CTave=ICT/L_{CT} Formula (2)
ICT: integral value of tensile stress (Pa·m)
L_{CT}: length (μm) of tensile stress region in sheet thickness direction
11. The chemically strengthened glass according to any one of above 1 to 10, in which the thickness t is 300 μm to 1500 μm.
12. The chemically strengthened glass according to any one of above 1 to 11, in which
−1000 MPa/μm<P₀<−225 MPa/μm is satisfied, provided that P₀ is an inclination of a glass surface layer defined by a formula CS₀/D, and in the formula, CS₀ is the surface compressive stress value (MPa), and D is the K ion penetration depth (μm).
13. The chemically strengthened glass according to any one of above 1 to 12, in which
   |P₅₀₋₉₀|>|P_{90-DOL}|, 1.8<|P₅₀₋₉₀|<6.0 and 1.5<|P_{90-DOL}|<4.0 are satisfied, provided that P₅₀₋₉₀ (MPa/μm) is an inclination of a stress profile of the chemically strengthened glass in a region between the depth of 50 μm from the surface of the chemically strengthened glass and the depth of 90 μm from the surface of the chemically strengthened glass, and P_{90-DOL} (MPa/μm) is an inclination of a stress profile of the chemically strengthened glass in a region between the depth of 90 μm from the surface of the chemically strengthened glass and a depth (DOL) (μm) at which a compressive stress value is zero,
provided that the P₅₀₋₉₀ and the P_{90-DOL} are calculated by the following formulas,

P₅₀₋₉₀=(CS₅₀−CS₉₀)/40; and

P_{90-DOL}=CS₉₀/(DOL−90).
14. The chemically strengthened glass according to any one of above 1 to 13, in which
   |P₅₀₋₉₀|<|P_{90-DOL}|, 1.0<|P₅₀₋₉₀|<3.0 and 1.2<|P_{90-DOL}|<4.0 are satisfied, provided that P₅₀₋₉₀ (MPa/μm) is an inclination of a stress profile of the chemically strengthened glass in a region between the depth of 50 μm from the surface of the chemically strengthened glass and the depth of 90 μm from the surface of the chemically strengthened glass, and P_{90-DOL} (MPa/μm) is an inclination of a stress profile of the chemically strengthened glass in a region between the depth of 90 μm from the surface of the chemically strengthened glass and a depth (DOL) (μm) at which a compressive stress value is zero,
provided that the P₅₀₋₉₀ and the P_{90-DOL} are calculated by the following formulas,

P₅₀₋₉₀=(CS₅₀−CS₉₀)/40; and

P_{90-DOL}=CS₉₀/(DOL−90).
15. A method for producing a chemically strengthened glass including Li₂O, K₂O, and Na₂O, the method including chemically strengthening a glass having a thickness of t [μm] and including Li₂O, in which
chemical strengthening is performed so that a minimum depth z at which Kₓ is (K_{t/2}+0.1) [%] or more is 0.5 μm to 5 μm, provided that K_{t/2} [%] is a concentration of K₂O at a depth of x [μm] from a surface of the chemically strengthened glass and K_{t/2} [%] is a content of K₂O of the glass before the chemical strengthening, in terms of mole percentage based on oxides of the chemically strengthened glass.
16. The method for producing a chemically strengthened glass according to above 15, in which
the glass including Li₂O includes a glass ceramic.
17. The method for producing a chemically strengthened glass according to above 16, in which
the chemical strengthening includes two or more stages of ion exchange, and CTave after first ion exchange, which is initial ion exchange, is larger than CTA, provided that the CTA is calculated by the following Formula (1), and the CTave is calculated by the following Formula (2).

[Math. 5]

CTA=317.93×K1c/\sqrt{t}+228.5×t−398 Formula (1)
t: sheet thickness (μm)
K1c: fracture toughness value (MPa-m¹²)

CTave=ICT/L_{CT} Formula (2)
ICT: integral value of tensile stress (Pa m)
L_{CT}: length (μm) of tensile stress region in sheet thickness direction

### EXAMPLES

Hereinafter, the present invention will be described with reference to Examples, but the present invention is not limited thereto.

<Production and Evaluation of Amorphous Glass>

Glass raw materials were blended so as to obtain a glass composition shown in Table 1 in terms of mol % based on oxides, and weighed out to give 800 g of glass. Next, the mixed glass raw materials were put in a platinum crucible, put into an electric furnace at 1600° C., melted for about 5 hours, defoamed, and homogenized.

The obtained molten glass was poured into a mold, held at a temperature of a glass transition point for 1 hour, and then cooled to room temperature at a rate of 0.5° C./min to obtain a glass block. Table 1 shows the results of evaluating the glass transition point, specific gravity, Young's modulus, and fracture toughness value of the amorphous glass using a part of the obtained block

In the table, R₂O represents the total content of Li₂O, Na₂O, and K₂O, and NWF represents the total content of SiO₂, Al₂O₃, P₂O₅, and B₂O₃.

(Specific Gravity ρ)

Measurement was performed by the Archimedes method.

(Glass Transition Point Tg)

The glass was pulverized using an agate mortar, about 80 mg of powder was put into a platinum cell, the temperature was increased from room temperature to 1100° C. at a temperature rising rate of 10/min, and a DSC curve was measured using a differential scanning calorimeter (DSC3300SA manufactured by Bruker Corporation) to determine a glass transition point Tg.

Alternatively, based on JIS R1618:2002, a thermal expansion curve was obtained at a temperature rising rate 10° C./min using a thermal dilatometer (TD5000SA manufactured by Bruker AXS Inc.), and a glass transition point Tg [unit: ° C.] was calculated based on the obtained thermal expansion curve.

(Haze Value)

Using a haze meter (HZ-V3 manufactured by Suga Test Instruments Co., Ltd.), a haze value [unit: %] under a halogen lamp C light source was measured.

(Young's Modulus E)

Measurement was performed by an ultrasonic method.

(Fracture Toughness Value Kc)

Measurement was performed by the IF method in accordance with JIS R1607: 2015.

[CTAValue]

A CTA value was determined from the following formula (1).

[Math. 6]

CTA=317.93×K1c/\sqrt{t}+228.5×t−398 Formula (1)
T: sheet thickness (μm)
K1c: fracture toughness value (MPa·m^{1/2})

TABLE 1

| | G1 | G2 |
|---|---|---|
| SiO₂ | 61.0 | 51.2 |
| Al₂O₃ | 5.0 | 5.0 |
| P₂O₅ | 2.0 | 2.3 |
| Li₂O | 21.0 | 34.1 |
| Na₂O | 2.0 | 1.8 |
| MgO | 5.0 | 0.0 |
| ZrO₂ | 3.0 | 4.5 |
| Y₂O₃ | 1.0 | 1.0 |
| R₂O | 23.0 | 35.9 |
| NWF | 68.0 | 58.5 |
| ρ (g/cm³) | 2.56 | 2.57 |
| Tg (° C.) | 513 | 494 |
| Haze (%) | 0.02 | 0.02 |
| E (GPa) | 90 | 97 |
| Kc (MPa · m^{1/2}) | 0.98 | 0.86 |

<Crystallization Treatment and Evaluation of Glass Ceramics>

The obtained glass block was processed into a size of 50 mm×50 mm×1.5 mm, and then heat-treated under conditions described in Table 2 to obtain glass ceramics. In the column of the crystallization conditions in the Table, the upper row is nucleation treatment conditions and the lower row is crystal growth treatment conditions. For example, in a case where the upper row describes 550° C. and 2 h and the lower row describes 730° C. and 2 h, it means that the glass is held at 550° C. for 2 hours and then held at 730° C. for 2 hours.

The obtained glass ceramics were processed and mirror-polished to obtain a glass ceramic sheet having a thickness t of 700 μm. In addition, a rod-shaped sample for measuring a thermal expansion coefficient was prepared. A part of the remaining glass ceramics was pulverized and used for analysis of precipitated crystals. The evaluation results of the glass ceramics are shown in Table 2.

(X-ray Diffraction: Precipitated Crystals)

Powder X-ray diffraction was measured under the following conditions to identify precipitated crystals.
Measurement device: Smart Lab manufactured by Rigaku Corporation
X-ray used: CuKα ray
Measurement range: 20=10° to 80°
Speed: 1°/min
Step: 0.01°

The detected main crystals are shown in the column of crystals in Table 2. Since Li₃PO₄ and Li₄SiO₄ are difficult to distinguish by the powder X-ray diffraction, both are described together.

(Haze Value)

Using a haze meter (HZ-V3 manufactured by Suga Test Instruments Co., Ltd.), a haze value [unit: %] under a halogen lamp C light source was measured.

TABLE 2

| Glass ceramic | CG1 | CG2 |
|---|---|---|
| Glass | G1 | G2 |
| Heat treatment conditions | 550° C. 2 h | 550° C. 2 h |
| | 750° C. 2 h | 710° C. 2 h |
| Crystals | Li₃PO₄ | Li₂SiO₃ |
| | Li₄SiO₄ | |
| Haze (%) | 0.03 | 0.08 |

<Chemical Strengthening Treatment and Evaluation of Strengthened Glass>

Glass ceramics CG1 and CG2 were chemically strengthened under the conditions shown in Table 3 to give Examples 1 to 7. Examples 1 to 4, 6, and 7 in Table 3 are working examples, and Example 5 is a comparative example. In Table 3, “%” represents “mass %”.

The evaluation results of the chemically strengthened glass are shown in Table 4. A blank (oblique line) indicates no evaluation. Stress profiles of Examples 1 and 5 are shown in FIG. 2. In Table 4, the sheet thickness is 700 mm in Examples 1 to 7, and the sheet thickness is 550 mm in Examples 8 and 9. Examples 1 to 4 and 6 to 9 are working examples, and Example 5 is a comparative example. Examples 8 and 9 were chemically strengthened under the same conditions as those of Examples 6 and 7 described in Table 3.

(EPMA)

The measurement by EPMA was performed as follows. First, a glass sample was embedded with an epoxy resin and mechanically polished in a direction perpendicular to a first main surface and a second main surface opposite to the first main surface to prepare a cross-sectional sample. A C coat was applied to the polished cross section, and measurement was performed using an EPMA (JXA-8500F manufactured by JEOL Ltd.). A line profile of X-ray intensity of K, Na or Li was acquired at intervals of 1 μm with an acceleration voltage of 15 kV, a probe current of 30 nA, and an integration time of 1000 msec./point.

(K Ion Penetration Depth)

The K ion penetration depth D was calculated by the following procedures (1) to (3).
(1) First, a profile of compressive stress values (CS) of a chemically strengthened glass in a depth direction was measured using the scattered light photoelastic stress meter SLP-2000 manufactured by Orihara Industrial Co., Ltd.
(2) Next, for the same chemically strengthened glass as the chemically strengthened glass whose profile of compressive stress values in a depth direction is measured using SLP-2000 in (1), the profile in a depth direction is measured by the following method.

While one surface of the glass was sealed, the glass was immersed in an acid of 1% HF-99% H₂O in terms of volume fraction, and only one surface was etched to arbitrary thickness. This caused a stress difference between front and back surfaces of the chemically strengthened glass, and the glass warped according to the stress difference. The amount of warpage was measured using a contact shape meter (Surftest manufactured by Mitutoyo Corporation) The amount of warpage was measured at three or more etching depths.

The obtained amount of warpage was converted into stress using the formula shown in the following document to obtain a profile of compressive stress values in the depth direction.

Document: G. G. Stoney, Proc. Roy. Soc. London Ser. A, 82, 172 (1909).
(3) The two profiles obtained by the procedures (1) and (2) are overlapped, and a depth of an intersection point is the “K ion penetration depth D”.

In Examples 6, 7, 8, and 9, the warpage caused by polishing using a rotary polishing machine (apparatus name: 9B-5P, manufacturer: SPEEDFAM) was measured with a contact shape meter (apparatus name: SV-600, manufacturer: Mitutoyo Corporation).

(Stress Profile)

A stress profile was measured using the scattered light photoelastic stress meter SLP-2000 manufactured by Orihara Industrial Co., Ltd.

(Surface Resistance)

The surface resistivity was measured using a non-contact conductivity meter (manufactured by DELCOM).

(Drop Test)

In a drop test, the obtained glass sample of 120×60×0.6 mmt was fitted into a structure whose mass and rigidity were adjusted according to a size of a general smartphone currently used, and thus a pseudo smartphone was prepared. Then, the pseudo smartphone was freely dropped onto #180 SiC sandpaper for #180 drop strength or onto #80 SiC sandpaper for #80 drop strength. A drop height was calculated by repeating an operation of dropping the glass sample from a height of 5 cm, and if the glass sample was not broken, raising the height by 5 cm and dropping the glass sample again until the glass sample was broken, and measuring an average value of heights of 10 sheets of glass samples when the glass samples were broken for the first time.

In the specification, AFP durability (10000 times) was measured by an eraser abrasion test under the following conditions.

Eraser Abrasion Test Conditions:

A surface of the chemically strengthened glass sheet was cleaned with ultraviolet rays, and was spray-coated with Optool (registered trademark) DSX (manufactured by Daikin Industries, Ltd.) to form a substantially uniform AFP film on the surface of the glass sheet.

An eraser (minoan, manufactured by MIRAE SCIENCE) was attached to an indenter of 1 cm², and a surface of the AFP film formed on the surface of the glass sheet was subjected to reciprocating friction 10000 times at a stroke width of 20 mm and a speed of 30 mm/sec under a load of 1 kgf. Then, the surface of the AFP film was cleaned by dry wiping with a cloth [DUSPER (registered trademark) manufactured by Ozu Corporation], and then water contact angles (°) were measured at three positions on the surface of the AFP film. The operation was repeated three times to measure an average water contact angle (°) of water contact angles at a total of nine positions. The water contact angle (°) on the surface of the AFP film was measured by a method in accordance with JIS R3257 (1999).

(4PB Strength)

A chemically strengthened glass was processed into a strip shape of 120 mm×60 mm, and a four-point bending test was performed under the conditions that a distance between external fulcrums of a support is 30 mm, a distance between internal fulcrums of the support is 10 mm, and a crosshead speed is 5.0 mm/min to measure four-point bending strength. The number of test pieces was 10. The chemically strengthened glass was processed into a strip shape, and then subjected to automatic chamfering (C-chamfering) using a grindstone having a grit size of 1000 (manufactured by Tokyo Diamond Tools Mfg. Co., Ltd.), and an end surface thereof was mirror-finished using a nylon brush having a diameter of 0.1 mm and SHOROX NZ abrasive grains (manufactured by Showa Denko K. K.) to obtain a 120×60×0.7 mm thick glass, and then the glass was measured. The results of evaluating measured values of the 4PB strength according to the following indexes are shown.
A: The 4PB strength is 779 MPa or more.
B: The 4PB strength is 600 MPa or more and less than 779 MPa.
C: The 4PB strength is less than 600 MPa.

TABLE 3

| | Ex. 1 | | Ex. 2 | | Ex. 3 | | Ex. 4 | | Ex. 5 | | Ex. 6 | | Ex. 7 | |
|---|---|---|---|---|---|---|---|---|---|---|---|---|---|---|
| Glass ceramic | CG1 | | CG1 | | CG1 | | CG2 | | CG1 | | CG1 | | CG1 | |
| First-stage strengthening salt | NaNO₃ | | NaNO₃ 20% + | | NaNO₃ 20% + | | NaNO₃ | | NaNO₃ | | NaNO₃ | | NaNO₃ 99.2% + | |
| | 100% | | KNO₃ 80% | | KNO₃ 80% | | 100% | | 100% | | 100% | | LiNO₃ 0.8% | |
| First-stage strengthening | 390° | C. | 410° | C. | 410° | C. | 390° | C. | 410° | C. | 390° | C. | 390° | C. |
| temperature | | | | | | | | | | | | | | |
| First-stage strengthening time | 5.5 | hour | 5 | hour | 5 | hour | 3 | hour | 5.5 | hour | 2.5 | hour | 5 | hour |

| Second-stage strengthening salt | KNO₃ 99.5% + | | KNO₃ 99.5% + | | KNO₃ 98.0% + | | KNO₃ 98.0% + | | No | KNO₃ | | KNO₃ 99.95% + | |
|---|---|---|---|---|---|---|---|---|---|---|---|---|---|
| | LiNO₃ 0.5% | | LiNO₃ 0.5% | | LiNO₃ 2% | | NaNO₃ 1.6% + | | | 100% | | LiNO₃ 0.05% | |
| | | | | | | | LiNO₃ 0.4% | | | | | | |
| Second-stage strengthening | 410° | C. | 410° | C. | 410° | C. | 390° | C. | No | 410° | C. | 410° | C. |
| temperature | | | | | | | | | | | | | |
| Second-stage strengthening time | 1 | hour | 1 | hour | 1 | hour | 30 | min | No | 1 | hour | 3 | hour |

| Third-stage strengthening salt | No | No | NaNO₃ 99.7% + | | No | No | No | No |
|---|---|---|---|---|---|---|---|---|
| | | | KNO₃ 0.3% | | | | | |
| Third-stage strengthening | No | No | 390° | C. | No | No | No | No |
| temperature | | | | | | | | |
| Third-stage strengthening time | No | No | 10 | min | No | No | No | No |

TABLE 4

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| t [μm] | 700 | 700 | 700 | 700 | 700 | 700 | 700 | 550 | 550 |
| CS₀ [MPa] | 700 | 710 | 680 | 750 | 600 | 892 | 918 | 892 | 918 |
| CS_{D} [MPa] | 271 | 313 | 280 | 345 | | 348 | 290 | 330 | 272 |
| CS₅₀ [MPa] | 220 | 240 | 210 | 230 | 200 | 203 | 146 | 189 | 125 |
| CS₉₀ [MPa] | 90 | 120 | 130 | 30 | 0 | 51 | 89 | 37 | 70 |
| CS_{t/2} [MPa] | −100 | −105 | −100 | −95 | −98 | −72 | −78 | −96 | −96 |
| DOL [μm] | 128 | 129 | 132 | 98 | 90 | 107 | 139 | 102 | 126 |
| z [μm] | 2 | 2.5 | 2.5 | 1.5 | 2 | 2 | 3 | 2 | 3 |
| K₁ [%] | 1.2 | 1 | 0.9 | 0.5 | 0 | 3.6 | 2.3 | 3.6 | 2.3 |
| K_{t/2} [%] | 0 | 0 | 0 | 0 | 0 | 0 | 0 | 0 | 0 |
| Na₁ [%] | 4.1 | 6.8 | 6.3 | 5.5 | 8 | 4.3 | 3.1 | 4.3 | 3.1 |
| Na_{z} [%] | 5.5 | 7.1 | 7.4 | 5.7 | | 8 | 5.9 | 8 | 5.9 |
| Na₅₀ [%] | 4.6 | 5.5 | 5.5 | 2.7 | 5.5 | 5.2 | 4.9 | 5.2 | 4.9 |
| Na_{t/2} [%] | 2 | 2 | 2 | 1.8 | 2 | 2 | 2 | 2 | 2 |
| Li_{t/2} [%] | 21 | 21 | 21 | 34.1 | 21 | 21 | 21 | 21 | 21 |
| D [μm] | 1.7 | 2.4 | 2.3 | 1.4 | | 1.8 | 2.7 | 1.8 | 2.7 |
| CS₅₀/(Na₅₀ − Na_{t/2}) [MPa/%] | 84.6 | 68.6 | 60.0 | 255.6 | 57.1 | 63.4 | 50.3 | 59.1 | 43.1 |
| Na_{z} − Na₅₀ [%] | 0.9 | 1.6 | 1.9 | 3 | | 2.8 | 1 | 2.8 | 1 |
| Na_{z} − Na_{t/2} [%] | 3.5 | 5.1 | 5.4 | 3.9 | | 6 | 3.9 | 6 | 3.9 |
| Li_{t/2} + Na_{t/2} + K_{t/2} − 2Na₁ − 2K₁ [%] | 12.4 | 7.4 | 8.6 | 23.9 | 7 | 7.2 | 12.2 | 7.2 | 12.2 |
| Fracture toughness value [MPa · m^{1/2}] | 0.88 | 0.88 | 0.88 | 0.91 | 0.88 | 0.88 | 0.88 | 0.88 | 0.88 |
| Surface resistance log ρ [Ω · cm] | 10 | 10 | 10 | 9.8 | 10.5 | 10 | 10 | 10 | 10 |
| #180 drop strength [cm] | 180 | 200 | 170 | 210 | 160 | 160 | 110 | 150 | 100 |
| #80 drop strength [cm] | 70 | 80 | 80 | 60 | 30 | 50 | 70 | 40 | 60 |
| AFP durability (10000 times) | 110 | 105 | 105 | 110 | 95 | 110 | 105 | 110 | 105 |
| | degrees | degrees | degrees | degrees | degrees | degrees | degrees | degrees | degrees |
| CTA | 96 | 96 | 96 | 108 | 96 | 96 | 96 | 105 | 105 |
| CTave after first ion exchange | 100 | 111 | 111 | 109 | — | 70 | 83 | 85 | 99 |
| CTave after second ion exchange | 76 | 95 | 91 | 94 | — | 69 | 71 | 80 | 71 |

As shown in Table 4 and FIG. 2, compared to Example 5 as a comparative example, in Examples 1 to 4 and 6 to 9 as working examples, it was found that the chemical strengthening properties were excellent, the AFP durability was high, and peeling of a coating could be effectively prevented. In Examples 1 to 4, the compressive stress was introduced to a range exceeding the CT limit after the first ion exchange, and the stress value of the glass surface layer was reduced in the second ion exchange process.

Table 5 shows the results of measuring the 4PB strength for Examples 1, 6, and 7.

TABLE 5

| | Example 1 | Example 6 | Example 7 |
|---|---|---|---|
| Glass ceramic | CG1 | CG1 | CG1 |
| 4PB strength (MPa) | 589 | 836 | 779 |
| 4PB strength | C | A | A |

As shown in Table 5, the chemically strengthened glass in Examples 6 and 7 exhibited higher values of the 4PB strength (MPa) than the chemically strengthened glass in Example 1. From the viewpoint of obtaining a chemically strengthened glass having higher bending strength, Examples 6 and 7 are preferable because the 4PB strength (MPa) exceeds 550 MPa. It was found that the conditions of CS₀ shown in Table 4 contribute to the achievement of such excellent 4PB strength.

Further, for the chemically strengthened glass in Examples 1 to 9, Table 6 shows the results of measuring an inclination P₀ of the glass surface layer, an inclination |P₅₀₋₉₀| of the stress profile of the chemically strengthened glass in the region between the depth of 50 μm from the surface and the depth of 90 μm from the surface, and an inclination |P_{90-DOL}| of the stress profile of the chemically strengthened glass in the region between the depth of 90 μm from the surface and the depth (DOL) (μm) at which a compressive stress value is zero. A blank (oblique line) indicates no evaluation.

TABLE 6

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| P₀ [MPa/μm] | −412 | −296 | −296 | −536 | | −496 | −340 | −496 | −340 |
| \|P₅₀₋₉₀\| [MPa/μm] | 3.3 | 3.0 | 2.0 | 5.0 | 5.0 | 3.8 | 1.4 | 3.8 | 1.4 |
| \|P_{90-DOL}\| [MPa/μm] | 2.4 | 3.1 | 3.1 | 3.8 | 0.0 | 3.0 | 1.8 | 3.1 | 1.9 |

As shown in Table 6, compared to Example 5 as a comparative example, in Examples 1 to 4 and 6 to 9 as working examples, it was confirmed that the value of P₀ was in a range of −1000 MPa/μm<P₀<−225 MPa/μm, and the 4PB strength was in the range exceeding 550 MPa.

In Examples 1, 4, 6, and 8 in which the value of |P₅₀₋₉₀| (MPa/μm) was |P₅₀₋₉₀|>|P_{90-DOL}|, and 1.8<|P₅₀₋₉₀|<6.0 and 1.5<|P_{90-DOL}|<4.0, it was confirmed that the #180 drop strength was 100 cm or more.

Furthermore, in Examples 2, 3, 7, and 9 in which |P₅₀₋₉₀|<|P_{90-DOL}|, and 1.0<|P₅₀₋₉₀|<3.0 and 1.2<|P_{90-DOL}|<4.0, it was confirmed that the #80 drop strength was 40 cm or more.

Although the present invention has been described in detail with reference to specific aspects, it is apparent to those skilled in the art that various changes and modifications can be made without departing from the spirit and scope of the present invention. The present application is based on a Japanese patent application (No. 2021-065434) filed on Apr. 7, 2021, and a Japanese patent application (No. 2021-206353) filed on Dec. 20, 2021, the entire contents of which are incorporated herein by reference. In addition, all references cited here are entirely incorporated.

What is claimed is:

1. A chemically strengthened glass having a thickness of t [μm] and comprising Li₂O, K₂O, and Na₂O, wherein
a minimum depth z at which Kₓ is (K_{t/2}+0.1) [%] or more is 0.5 μm to 5 μm, provided that Kₓ [%] is a concentration of K₂O at a depth of x [μm] from a surface of the chemically strengthened glass and K_{t/2} [%] is a content of K₂O before chemical strengthening, in terms of mole percentage based on oxides.

2. The chemically strengthened glass according to claim 1, wherein

|Na_{z}−Na₅₀|<3 [%] is satisfied, provided that Na_{z} [%] is a concentration of Na₂O at the minimum depth z [μm] at which Kₓ is (K_{t/2}+0.1) [%] or more where Kₓ [%] is the concentration of K₂O at the depth of x [μm] from the surface of the chemically strengthened glass and K_{t/2} [%] is the content of K₂O before chemical strengthening, and Na₅₀ [%] is a concentration of Na₂O at a depth of 50 μm from the surface of the chemically strengthened glass, in terms of mole percentage based on oxides.

3. The chemically strengthened glass according to claim 1, wherein
Na₅₀<Na_{t/2}+7 [%] is satisfied, provided that Na₅₀ [%] is a concentration of Na₂O at a depth of 50 μm from the surface of the chemically strengthened glass and Na_{t/2} [%] is a content of Na₂O before chemical strengthening, in terms of mole percentage based on oxides.

4. The chemically strengthened glass according to claim 1, wherein
(Li_{t/2}+Na_{t/2}+K_{t/2})−2(Na₁+K₁)>0 [%] is satisfied, provided that K₁ [%] is a concentration of K₂O at a depth of 1 μm from the surface of the chemically strengthened glass, Na₁ [%] is a concentration of Na₂O at a depth of 1 μm from the surface of the chemically strengthened glass, and Li_{t/2} [%], Na_{t/2} [%], and K_{t/2} [%] are contents of Li₂O, Na₂O, and K₂O before chemical strengthening, respectively, in terms of mole percentage based on oxides.

5. The chemically strengthened glass according to claim 1, having a surface compressive stress value CS₀ of 450 MPa or more, a compressive stress value CS₅₀ at a depth of 50 μm from the surface of the chemically strengthened glass of 150 MPa or more, and a compressive stress value CS₉₀ at a depth of 90 μm from the surface of the chemically strengthened glass of 30 MPa or more.

6. The chemically strengthened glass according to claim 1, having a surface compressive stress value CS₀ of 450 MPa or more, a compressive stress value CS₅₀ at a depth of 50 μm from the surface of the chemically strengthened glass of y=124.7×t+21.5 [MPa] or more, and a compressive stress value CS₉₀ at a depth of 90 μm from the surface of the chemically strengthened glass of y=99.1×t×38.3 [MPa] or more.

7. A chemically strengthened glass, wherein
a K ion penetration depth D is 0.5 μm to 5 μm,
an absolute value of a difference between a compressive stress value at the K ion penetration depth D and a compressive stress value CS₅₀ at a depth of 50 μm from a surface of the chemically strengthened glass is 150 MPa or less,
the compressive stress value at the K ion penetration depth D is 350 MPa or less, and
a surface compressive stress value CS₀ is 450 MPa or more, the compressive stress value CS₅₀ at the depth of 50 μm from the surface of the chemically strengthened glass is 150 MPa or more, and a compressive stress value CS₉₀ at a depth of 90 μm from the surface of the chemically strengthened glass is 30 MPa or more.

8. The chemically strengthened glass according to claim 1, comprising a glass ceramic.

9. The chemically strengthened glass according to claim 1, having a base composition comprising 40% to 75% of SiO₂, 1% to 20% of Al₂O₃, and 5% to 35% of Li₂O in terms of mole percentage based on oxides.

10. The chemically strengthened glass according to claim 1, which is subjected to two or more stages of ion exchange, wherein
CTave after first ion exchange, which is initial ion exchange, is larger than CTA, provided that the CTA is calculated by the following Formula (1), and the CTave is calculated by the following Formula (2):
[Math. 1]
CTA=317.93×K1c/\sqrt{t}+228.5×t−398 Formula (1)
t: sheet thickness (μm)
K1c: fracture toughness value (MPa·m^{1/2})
CTave=ICT/L_{CT} Formula (2)
ICT: integral value of tensile stress (Pa·m)
L_{CT}: length (μm) of tensile stress region in sheet thickness direction.

11. The chemically strengthened glass according to claim 1, wherein the thickness t is 300 μm to 1500 μm.

12. The chemically strengthened glass according to claim 1, wherein
−1000 MPa/μm<P₀<−225 MPa/μm is satisfied, provided that P₀ is an inclination of a glass surface layer defined by a formula CS₀/D, and in the formula, CS₀ is the surface compressive stress value (MPa), and D is the K ion penetration depth (μm).

13. The chemically strengthened glass according to claim 1, wherein

|P₅₀₋₉₀|>|P_{90-DOL}|, 1.8<|P₅₀₋₉₀|<6.0 and 1.5<|P_{90-DOL}|<4.0 are satisfied, provided that P₅₀₋₉₀ (MPa/μm) is an inclination of a stress profile of the chemically strengthened glass in a region between the depth of 50 μm from the surface of the chemically strengthened glass and the depth of 90 μm from the surface of the chemically strengthened glass, and P_{90-DOL} (MPa/μm) is an inclination of a stress profile of the chemically strengthened glass in a region between the depth of 90 μm from the surface of the chemically strengthened glass and a depth (DOL) (μm) at which a compressive stress value is zero,
provided that the P₅₀₋₉₀ and the P_{90-DOL} are calculated by the following formulas,
P₅₀₋₉₀=(CS₅₀−CS₉₀)/40; and
P_{90-DOL}=CS₉₀/(DOL−90).

14. The chemically strengthened glass according to claim 1, wherein

|P₅₀₋₉₀|<|P_{90-DOL}|, 1.0<|P₅₀₋₉₀|<3.0 and 1.2<|P_{90-DOL}|<4.0 are satisfied, provided that P₅₀₋₉₀ (MPa/μm) is an inclination of a stress profile of the chemically strengthened glass in a region between the depth of 50 μm from the surface of the chemically strengthened glass and the depth of 90 μm from the surface of the chemically strengthened glass, and P_{90-DOL} (MPa/μm) is an inclination of a stress profile of the chemically strengthened glass in a region between the depth of 90 μm from the surface of the chemically strengthened glass and a depth (DOL) (μm) at which a compressive stress value is zero,
provided that the P₅₀₋₉₀ and the P_{90-DOL} are calculated by the following formulas,
P₅₀₋₉₀=(CS₅₀−CS₉₀)/40; and
P_{90-DOL}=CS₉₀/(DOL−90).

15. The chemically strengthened glass according to claim 7, comprising a glass ceramic.

16. The chemically strengthened glass according to claim 7, having a base composition comprising 40% to 75% of SiO₂, 1% to 20% of Al₂O₃, and 5% to 35% of Li₂O in terms of mole percentage based on oxides.

17. The chemically strengthened glass according to claim 7, which is subjected to two or more stages of ion exchange, wherein
CTave after first ion exchange, which is initial ion exchange, is larger than CTA, provided that the CTA is calculated by the following Formula (1), and the CTave is calculated by the following Formula (2):
[Math. 1]
CTA=317.93×K1c/\sqrt{t}+228.5×t−398 Formula (1)
t: sheet thickness (μm)
K1c: fracture toughness value (MPa·m^{1/2})
CTave=ICT/L_{CT} Formula (2)
ICT: integral value of tensile stress (Pa·m)
L_{CT}: length (μm) of tensile stress region in sheet thickness direction.

18. The chemically strengthened glass according to claim 7, wherein
−1000 MPa/μm<P₀<−225 MPa/μm is satisfied, provided that P₀ is an inclination of a glass surface layer defined by a formula CS₀/D, and in the formula, CS₀ is the surface compressive stress value (MPa), and D is the K ion penetration depth (μm).

19. The chemically strengthened glass according to claim 7, wherein

|P₅₀₋₉₀|>|P_{90-DOL}|, 1.8<|P₅₀₋₉₀|<6.0 and 1.5<|P_{90-DOL}|<4.0 are satisfied, provided that P₅₀₋₉₀ (MPa/μm) is an inclination of a stress profile of the chemically strengthened glass in a region between the depth of 50 μm from the surface of the chemically strengthened glass and the depth of 90 μm from the surface of the chemically strengthened glass, and P_{90-DOL} (MPa/μm) is an inclination of a stress profile of the chemically strengthened glass in a region between the depth of 90 μm from the surface of the chemically strengthened glass and a depth (DOL) (μm) at which a compressive stress value is zero,
provided that the P₅₀₋₉₀ and the P_{90-DOL} are calculated by the following formulas,
P₅₀₋₉₀=(CS₅₀−CS₉₀)/40; and
P_{90-DOL}=CS₉₀/(DOL−90).

20. The chemically strengthened glass according to claim 7, wherein

|P₅₀₋₉₀|<|P_{90-DOL}|, 1.0<|P₅₀₋₉₀|<3.0 and 1.2<|P_{90-DOL}|<4.0 are satisfied, provided that P₅₀₋₉₀ (MPa/μm) is an inclination of a stress profile of the chemically strengthened glass in a region between the depth of 50 μm from the surface of the chemically strengthened glass and the depth of 90 μm from the surface of the chemically strengthened glass, and P_{90-DOL} (MPa/μm) is an inclination of a stress profile of the chemically strengthened glass in a region between the depth of 90 μm from the surface of the chemically strengthened glass and a depth (DOL) (μm) at which a compressive stress value is zero,
provided that the P₅₀₋₉₀ and the P_{90-DOL} are calculated by the following formulas,
P₅₀₋₉₀=(CS₅₀−CS₉₀)/40; and
P_{90-DOL}=CS₉₀/(DOL−90).
